(19) United States
(12) Patent Application Publication
(10) Pub. No.: US 2015/0166731 A1
(43) Pub. Date: Jun. 18, 2015

(54) Reinforced Poly(Arylene Sulfide) Polymer Compositions

(71) Applicant: Chevron Phillips Chemical Company LP, The Woodlands, TX (US)

(72) Inventors: William E. Sattich, Bartlesville, OK (US); Michael R. Greer, Bartlesville, OK (US)

(73) Assignee: Chevron Phillips Chemical Company LP, The Woodlands, TX (US)

(21) Appl. No.: 14/107,666

(22) Filed: Dec. 16, 2013

(51) Int. Cl. C08G 75/14

(52) U.S. Cl. CPC C08G 75/14

(57) ABSTRACT

A reinforced poly(arylene sulfide) polymer composition comprising (a) a poly(arylene sulfide) polymer, (b) a hydroxyl-functionalized reinforcing material, and (c) an ureido silane coupling agent comprising a compound represented by Formula IV and/or a compound represented by Formula V:

H₂N—CO—NH—CₘH₂ₘ—Si(OR⁵)₃ Formula IV

H₂N—CO—NH—CₓH_{y}—Si(OR⁵)₃ Formula V

wherein m is an integer with a value of equal to or greater than 1; wherein x and y both are integers; wherein x has a value of equal to or greater than 1; wherein y has a value of equal to or greater than 2; wherein R⁵ is any hydrocarbon functionality; wherein the hydroxyl-functionalized reinforcing material is present in the reinforced poly(arylene sulfide) polymer composition in an amount of from about 30 wt. % to about 45 wt. %; and wherein the ureido silane coupling agent is present in the reinforced poly(arylene sulfide) polymer composition in an amount of from about 0.1 wt. % to about 1 wt. %.

### TECHNICAL FIELD

The present disclosure relates to novel polymer compositions and methods of making and using same. More specifically, the present disclosure relates to reinforced polymer compositions, such as for example reinforced poly(arylene sulfide) polymer compositions.

### BACKGROUND

Polymer compositions, such as poly(arylene sulfide) polymer compositions, are used for the production of a wide variety of articles. The use of a particular polymer composition in a particular application will depend on the type of physical and/or mechanical properties displayed by the polymer. Thus, there is an ongoing need to develop polymers that display novel physical and/or mechanical properties and methods for producing these polymers.

### BRIEF SUMMARY

Disclosed herein is a reinforced poly(arylene sulfide) polymer composition comprising (a) a poly(arylene sulfide) polymer, (b) a hydroxyl-functionalized reinforcing material, and (c) an ureido silane coupling agent comprising a compound represented by Formula IV and/or a compound represented by Formula V:

H₂N—CO—NH—CₘH₂ₘ—Si(OR⁵)₃ Formula IV

H₂N—CO—NH—CₓH_{y}—Si(OR⁵)₃ Formula V

wherein m is an integer with a value of equal to or greater than 1; wherein x and y both are integers; wherein x has a value of equal to or greater than 1; wherein y has a value of equal to or greater than 2; wherein R⁵ is any hydrocarbon functionality; wherein the hydroxyl-functionalized reinforcing material is present in the reinforced poly(arylene sulfide) polymer composition in an amount of from about 30 wt. % to about 45 wt. % based on the total weight of the reinforced poly(arylene sulfide) polymer composition; and wherein the ureido silane coupling agent is present in the reinforced poly(arylene sulfide) polymer composition in an amount of from about 0.1 wt. % to about 1 wt. % based on the total weight of the reinforced poly(arylene sulfide) polymer composition.

Also disclosed herein is a method comprising compound extruding a reinforced poly(arylene sulfide) polymer composition in a compounding extruder and forming an extruded article, wherein the reinforced poly(arylene sulfide) polymer composition comprises (a) a poly(arylene sulfide) polymer; (b) a hydroxyl-functionalized reinforcing material; and (c) an ureido silane coupling agent comprising a compound represented by Formula IV and/or a compound represented by Formula V:

H₂N—CO—NH—CₘH₂ₘ—Si(OR⁵)₃ Formula IV

H₂N—CO—NH—CₓH_{y}—Si(OR⁵)₃ Formula V

wherein m is an integer with a value of equal to or greater than 1; wherein x and y both are integers; wherein x has a value of equal to or greater than 1; wherein y has a value of equal to or greater than 2; wherein R⁵ is any hydrocarbon functionality; wherein the hydroxyl-functionalized reinforcing material is present in the reinforced poly(arylene sulfide) polymer composition in an amount of from about 30 wt. % to about 45 wt. % based on the total weight of the reinforced poly(arylene sulfide) polymer composition; and wherein the ureido silane coupling agent is present in the reinforced poly(arylene sulfide) polymer composition in an amount of from about 0.1 wt. % to about 1 wt. % based on the total weight of the reinforced poly(arylene sulfide) polymer composition.

Further disclosed herein is an extruded or molded article comprising a reinforced poly(arylene sulfide) polymer composition comprising (a) a poly(arylene sulfide) polymer; (b) a hydroxyl-functionalized reinforcing material; and (c) an ureido silane coupling agent comprising a compound represented by Formula IV and/or a compound represented by Formula V:

H₂N—CO—NH—CₘH₂ₘ—Si(OR⁵)₃ Formula IV

H₂N—CO—NH—CₓH_{y}—Si(OR⁵)₃ Formula V

wherein m is an integer with a value of equal to or greater than 1; wherein x and y both are integers; wherein x has a value of equal to or greater than 1; wherein y has a value of equal to or greater than 2; wherein R⁵ is any hydrocarbon functionality; wherein the hydroxyl-functionalized reinforcing material is present in the reinforced poly(arylene sulfide) polymer composition in an amount of from about 30 wt. % to about 45 wt. % based on the total weight of the reinforced poly(arylene sulfide) polymer composition; and wherein the ureido silane coupling agent is present in the reinforced poly(arylene sulfide) polymer composition in an amount of from about 0.1 wt. % to about 1 wt. % based on the total weight of the reinforced poly(arylene sulfide) polymer composition.

Further disclosed herein is a reinforced poly(phenylene sulfide) polymer composition comprising (a) a poly(phenylene sulfide) polymer; (b) a hydroxyl-functionalized reinforcing material comprising glass fibers; and (c) an ureido silane coupling agent comprising a γ-ureidopropyltrimethoxy silane represented by Formula VII and/or a γ-ureidopropyltriethoxy silane represented by Formula VIII:

H₂N—CO—NH—CH₂—CH₂—CH₂—Si(OCH₃)₃ Formula VII

H₂N—CO—NH—CH₂—CH₂—CH₂—Si(OC₂H₅)₃ Formula VIII

wherein the hydroxyl-functionalized reinforcing material is present in the reinforced poly(phenylene sulfide) polymer composition in an amount of from about 30 wt. % to about 45 wt. % based on the total weight of the reinforced poly(phenylene sulfide) polymer composition; and wherein the ureido silane coupling agent is present in the reinforced poly(phenylene sulfide) polymer composition in an amount of from about 0.1 wt. % to about 1 wt. % based on the total weight of the reinforced poly(phenylene sulfide) polymer composition.

Further disclosed herein is a method comprising compound extruding a reinforced poly(phenylene sulfide) polymer composition in a compounding extruder and forming an extruded article, wherein the reinforced poly(phenylene sulfide) polymer composition comprises (a) a poly(phenylene sulfide) polymer; (b) a hydroxyl-functionalized reinforcing material comprising glass fibers; and (c) an ureido silane coupling agent comprising a γ-ureidopropyltrimethoxy silane represented by Formula VII and/or a γ-ureidopropyltriethoxy silane represented by Formula VIII:

H₂N—CO—NH—CH₂—CH₂—CH₂—Si(OCH₃)₃ Formula VII

H₂N—CO—NH—CH₂—CH₂—CH₂—Si(OC₂H₅)₃ Formula VIII

wherein the hydroxyl-functionalized reinforcing material is present in the reinforced poly(phenylene sulfide) polymer composition in an amount of from about 30 wt. % to about 45 wt. % based on the total weight of the reinforced poly(phenylene sulfide) polymer composition; and wherein the ureido silane coupling agent is present in the reinforced poly(phenylene sulfide) polymer composition in an amount of from about 0.1 wt. % to about 1 wt. % based on the total weight of the reinforced poly(phenylene sulfide) polymer composition.

Further disclosed herein is an extruded or molded article comprising a reinforced poly(phenylene sulfide) polymer composition comprising (a) a poly(phenylene sulfide) polymer; (b) a hydroxyl-functionalized reinforcing material comprising glass fibers; and (c) an ureido silane coupling agent comprising a γ-ureidopropyltrimethoxy silane represented by Formula VII and/or a γ-ureidopropyltriethoxy silane represented by Formula VIII:

H₂N—CO—NH—CH₂—CH₂—CH₂—Si(OCH₃)₃ Formula VII

H₂N—CO—NH—CH₂—CH₂—CH₂—Si(OC₂H₅)₃ Formula VIII

wherein the hydroxyl-functionalized reinforcing material is present in the reinforced poly(phenylene sulfide) polymer composition in an amount of from about 30 wt. % to about 45 wt. % based on the total weight of the reinforced poly(phenylene sulfide) polymer composition; and wherein the ureido silane coupling agent is present in the reinforced poly(phenylene sulfide) polymer composition in an amount of from about 0.1 wt. % to about 1 wt. % based on the total weight of the reinforced poly(phenylene sulfide) polymer composition.

Further disclosed herein is a hot water conveyance assembly comprising at least one fiber-reinforced, extruded component in contact with said hot water, wherein said fiber-reinforced, extruded component is formed via extrusion of a reinforced poly(phenylene sulfide) polymer composition comprising (a) a poly(phenylene sulfide) polymer; (b) a hydroxyl-functionalized reinforcing material comprising glass fibers; and (c) an ureido silane coupling agent comprising a γ-ureidopropyltrimethoxy silane represented by Formula VII and/or a γ-ureidopropyltriethoxy silane represented by Formula VIII:

H₂N—CO—NH—CH₂—CH₂—CH₂—Si(OCH₃)₃ Formula VII

H₂N—CO—NH—CH₂—CH₂—CH₂—Si(OC₂H₅)₃ Formula VIII

wherein the hydroxyl-functionalized reinforcing material is present in the reinforced poly(phenylene sulfide) polymer composition in an amount of from about 30 wt. % to about 45 wt. % based on the total weight of the reinforced poly(phenylene sulfide) polymer composition; and wherein the ureido silane coupling agent is present in the reinforced poly(phenylene sulfide) polymer composition in an amount of from about 0.1 wt. % to about 1 wt. % based on the total weight of the reinforced poly(phenylene sulfide) polymer composition.

### DETAILED DESCRIPTION

Disclosed herein are polymer compositions and methods of making and using same. In an embodiment, a polymer composition comprises a polymer, a reinforcing material, and a coupling agent, hereinafter termed reinforced polymer composition. In an embodiment, a poly(arylene sulfide) polymer composition comprises a poly(arylene sulfide) polymer, a hydroxyl-functionalized reinforcing material, and an ureido silane coupling agent, hereinafter termed reinforced poly(arylene sulfide) polymer composition. The present application relates to poly(arylene sulfide) polymers, also referred to herein simply as “poly(arylene sulfide).” In the various embodiments disclosed herein, it is to be expressly understood that reference to poly(arylene sulfide) polymer specifically includes, without limitation, polyphenylene sulfide polymer (or simply, polyphenylene sulfide), also referred to as PPS polymer (or simply, PPS).

In an embodiment, the reinforced poly(arylene sulfide) polymer composition disclosed herein can exhibit improvements in one or more physical and/or mechanical properties when compared to an otherwise similar poly(arylene sulfide) polymer composition lacking the ureido silane coupling agent. For example, reinforced poly(arylene sulfide) polymer composition of the type disclosed herein can be characterized by an improved stability (e.g., hydrolytic stability or resistance to hydrolysis) when compared to an otherwise similar poly(arylene sulfide) polymer composition lacking the ureido silane coupling agent. While the present disclosure will be discussed in detail in the context of reinforced poly(arylene sulfide) polymer compositions comprising a poly(arylene sulfide) polymer, a hydroxyl-functionalized reinforcing material, and an ureido silane coupling agent, it should be understood that other reinforced polymer compositions can comprise a polymer, a hydroxyl-functionalized reinforcing material, and an ureido silane coupling agent. The polymer can comprise any polymer compatible with the disclosed processes and materials. The polymer can be in any form. For example, the form of the polymer can be as a raw polymer, a treated polymer (e.g., acid treated polymer, metal cation treated polymer), a dried polymer, a cured polymer, or a polymer processed (e.g., melt processed, among other processed forms) into an easily handled form such as pellets; alternatively, a raw polymer; alternatively, a treated polymer; alternatively, a dried polymer; alternatively, a cured polymer; or alternatively, a processed polymer. In an embodiment, the reinforced polymer compositions can be characterized by improved physical and/or mechanical properties, e.g., stability (e.g., hydrolytic stability).

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997) can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Groups of elements of the table are indicated using the numbering scheme indicated in the version of the periodic table of elements published in Chemical and Engineering News, 63(5), 27, 1985. In some instances a group of elements can be indicated using a common name assigned to the group; for example alkali earth metals (or alkali metals) for Group 1 elements, alkaline earth metals (or alkaline metals) for Group 2 elements, transition metals for Group 3-12 elements, and halogens for Group 17 elements.

A chemical “group” is described according to how that group is formally derived from a reference or “parent” compound, for example, by the number of hydrogen atoms formally removed from the parent compound to generate the group, even if that group is not literally synthesized in this manner. These groups can be utilized as substituents or coordinated or bonded to metal atoms. By way of example, an “alkyl group” formally can be derived by removing one hydrogen atom from an alkane, while an “alkylene group” formally can be derived by removing two hydrogen atoms from an alkane. Moreover, a more general term can be used to encompass a variety of groups that formally are derived by removing any number (“one or more”) hydrogen atoms from a parent compound, which in this example can be described as an “alkane group,” and which encompasses an “alkyl group,” an “alkylene group,” and materials have three or more hydrogens atoms, as necessary for the situation, removed from the alkane. Throughout, the disclosure that a substituent, ligand, or other chemical moiety can constitute a particular “group” implies that the well-known rules of chemical structure and bonding are followed when that group is employed as described. When describing a group as being “derived by,” “derived from,” “formed by,” or “formed from,” such terms are used in a formal sense and are not intended to reflect any specific synthetic methods or procedure, unless specified otherwise or the context requires otherwise.

The term “substituted” when used to describe a group, for example, when referring to a substituted analog of a particular group, is intended to describe any non-hydrogen moiety that formally replaces a hydrogen in that group, and is intended to be non-limiting. A group or groups can also be referred to herein as “unsubstituted” or by equivalent terms such as “non-substituted,” which refers to the original group in which a non-hydrogen moiety does not replace a hydrogen within that group. “Substituted” is intended to be non-limiting and include inorganic substituents or organic substituents.

Unless otherwise specified, any carbon-containing group for which the number of carbon atoms is not specified can have, according to proper chemical practice, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 carbon atoms, or any range or combination of ranges between these values. For example, unless otherwise specified, any carbon-containing group can have from 1 to 30 carbon atoms, from 1 to 25 carbon atoms, from 1 to 20 carbon atoms, from 1 to 15 carbon atoms, from 1 to 10 carbon atoms, or from 1 to 5 carbon atoms, and the like. Moreover, other identifiers or qualifying terms can be utilized to indicate the presence or absence of a particular substituent, a particular regiochemistry and/or stereochemistry, or the presence or absence of a branched underlying structure or backbone.

Within this disclosure the normal rules of organic nomenclature will prevail. For instance, when referencing substituted compounds or groups, references to substitution patterns are taken to indicate that the indicated group(s) is (are) located at the indicated position and that all other non-indicated positions are hydrogen. For example, reference to a 4-substituted phenyl group indicates that there is a non-hydrogen substituent located at the 4 position and hydrogens located at the 2, 3, 5, and 6 positions. By way of another example, reference to a 3-substituted naphth-2-yl indicates that there is a non-hydrogen substituent located at the 3 position and hydrogens located at the 1, 4, 5, 6, 7, and 8 positions. References to compounds or groups having substitutions at positions in addition to the indicated position will be referenced using comprising or some other alternative language. For example, a reference to a phenyl group comprising a substituent at the 4 position refers to a group having a non-hydrogen atom at the 4 position and hydrogen or any non-hydrogen group at the 2, 3, 5, and 6 positions.

The term “organyl group” is used herein in accordance with the definition specified by IUPAC: an organic substituent group, regardless of functional type, having one free valence at a carbon atom. Similarly, an “organylene group” refers to an organic group, regardless of functional type, derived by removing two hydrogen atoms from an organic compound, either two hydrogen atoms from one carbon atom or one hydrogen atom from each of two different carbon atoms. An “organic group” refers to a generalized group formed by removing one or more hydrogen atoms from carbon atoms of an organic compound. Thus, an “organyl group,” an “organylene group,” and an “organic group” can contain organic functional group(s) and/or atom(s) other than carbon and hydrogen, that is, an organic group that can comprise functional groups and/or atoms in addition to carbon and hydrogen. For instance, non-limiting examples of atoms other than carbon and hydrogen include halogens, oxygen, nitrogen, phosphorus, and the like. Non-limiting examples of functional groups include ethers, aldehydes, ketones, esters, sulfides, amines, and phosphines, and so forth. In one aspect, the hydrogen atom(s) removed to form the “organyl group,” “organylene group,” or “organic group” can be attached to a carbon atom belonging to a functional group, for example, an acyl group (—C(O)R), a formyl group (—C(O)H), a carboxy group (—C(O)OH), a hydrocarboxycarbonyl group (—C(O)OR), a cyano group (—C≡N), a carbamoyl group (—C(O)NH₂), a N-hydrocarbylcarbamoyl group (—C(O)NHR), or N,N′-dihydrocarbylcarbamoyl group (—C(O)NR₂), among other possibilities. In another aspect, the hydrogen atom(s) removed to form the “organyl group,” “organylene group,” or “organic group” can be attached to a carbon atom not belonging to, and remote from, a functional group, for example, —CH₂C(O)CH₃, —CH₂NR₂. An “organyl group,” “organylene group,” or “organic group” can be aliphatic, inclusive of being cyclic or acyclic, or can be aromatic. “Organyl groups,” “organylene groups,” and “organic groups” also encompass heteroatom-containing rings, heteroatom-containing ring systems, heteroaromatic rings, and heteroaromatic ring systems. “Organyl groups,” “organylene groups,” and “organic groups” can be linear or branched unless otherwise specified. Finally, it is noted that the “organyl group,” “organylene group,” or “organic group” definitions include “hydrocarbyl group,” “hydrocarbylene group,” “hydrocarbon group,” respectively, and “alkyl group,” “alkylene group,” and “alkane group,” respectively, as members.

The term “hydrocarbon” whenever used in this specification and claims refers to a compound containing only carbon and hydrogen. Other identifiers can be utilized to indicate the presence of particular groups in the hydrocarbon (e.g. halogenated hydrocarbon indicates the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Similarly, a “hydrocarbylene group” refers to a group formed by removing two hydrogen atoms from a hydrocarbon, either two hydrogen atoms from one carbon atom or one hydrogen atom from each of two different carbon atoms. Therefore, in accordance with the terminology used herein, a “hydrocarbon group” refers to a generalized group formed by removing one or more hydrogen atoms (as necessary for the particular group) from a hydrocarbon. A “hydrocarbyl group,” “hydrocarbylene group,” and “hydrocarbon group” can be acyclic or cyclic groups, and/or can be linear or branched. A “hydrocarbyl group,” “hydrocarbylene group,” and “hydrocarbon group” can include rings, ring systems, aromatic rings, and aromatic ring systems, which contain only carbon and hydrogen. “Hydrocarbyl groups,” “hydrocarbylene groups,” and “hydrocarbon groups” include, by way of example, aryl, arylene, arene groups, alkyl, alkylene, alkane group, cycloalkyl, cycloalkylene, cycloalkane groups, aralkyl, aralkylene, and aralkane groups, respectively, among other groups as members.

The term “alkane” whenever used in this specification and claims refers to a saturated hydrocarbon compound. Other identifiers can be utilized to indicate the presence of particular groups in the alkane (e.g. halogenated alkane indicates the presence of one or more halogen atoms replacing an equivalent number of hydrogen atoms in the alkane). The term “alkyl group” is used herein in accordance with the definition specified by IUPAC: a univalent group formed by removing a hydrogen atom from an alkane. Similarly, an “alkylene group” refers to a group formed by removing two hydrogen atoms from an alkane (either two hydrogen atoms from one carbon atom or one hydrogen atom from two different carbon atoms). An “alkane group” is a general term that refers to a group formed by removing one or more hydrogen atoms (as necessary for the particular group) from an alkane. An “alkyl group,” “alkylene group,” and “alkane group” can be acyclic or cyclic groups, and/or can be linear or branched unless otherwise specified.

A “cycloalkane” is a saturated cyclic hydrocarbon, with or without side chains, for example, cyclobutane. Other identifiers can be utilized to indicate the presence of particular groups in the cycloalkane (e.g. halogenated cycloalkane indicates the presence of one or more halogen atoms replacing an equivalent number of hydrogen atoms in the cycloalkane). Unsaturated cyclic hydrocarbons having one or more endocyclic double or triple bonds are called cycloalkenes and cycloalkynes, respectively. Cycloalkenes and cycloalkynes having only one, only two, and only three endocyclic double or triple bonds, respectively, can be identified by use of the term “mono,” “di,” and “tri within the name of the cycloalkene or cycloalkyne. Cycloalkenes and cycloalkynes can further identify the position of the endocyclic double or triple bonds. Other identifiers can be utilized to indicate the presence of particular groups in the cycloalkane (e.g. halogenated cycloalkane indicates that the presence of one or more halogen atoms replacing an equivalent number of hydrogen atoms in the cycloalkane).

A “cycloalkyl group” is a univalent group derived by removing a hydrogen atom from a ring carbon atom from a cycloalkane. For example, a 1-methylcyclopropyl group and a 2-methylcyclopropyl group are illustrated as follows.

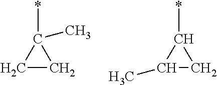

Similarly, a “cycloalkylene group” refers to a group derived by removing two hydrogen atoms from a cycloalkane, at least one of which is a ring carbon. Thus, a “cycloalkylene group” includes both a group derived from a cycloalkane in which two hydrogen atoms are formally removed from the same ring carbon, a group derived from a cycloalkane in which two hydrogen atoms are formally removed from two different ring carbons, and a group derived from a cycloalkane in which a first hydrogen atom is formally removed from a ring carbon and a second hydrogen atom is formally removed from a carbon atom that is not a ring carbon. A “cycloalkane group” refers to a generalized group formed by removing one or more hydrogen atoms (as necessary for the particular group and at least one of which is a ring carbon) from a cycloalkane. It should be noted that according to the definitions provided herein, general cycloalkane groups (including cycloalkyl groups and cycloalkylene groups) include those having zero, one, or more than one hydrocarbyl substituent groups attached to a cycloalkane ring carbon atom (e.g. a methylcyclopropyl group) and is member of the group of hydrocarbon groups. However, when referring to a cycloalkane group having a specified number of cycloalkane ring carbon atoms (e.g. cyclopentane group or cyclohexane group, among others), the base name of the cycloalkane group having a defined number of cycloalkane ring carbon atoms refers to the unsubstituted cycloalkane group. Consequently, a substituted cycloalkane group having a specified number of ring carbon atoms (e.g. substituted cyclopentane or substituted cyclohexane, among others) refers to the respective group having one or more substituent groups (including halogens, hydrocarbyl groups, or hydrocarboxy groups, among other substituent groups) attached to a cycloalkane group ring carbon atom. When the substituted cycloalkane group having a defined number of cycloalkane ring carbon atoms is a member of the group of hydrocarbon groups (or a member of the general group of cycloalkane groups), each substituent of the substituted cycloalkane group having a defined number of cycloalkane ring carbon atoms is limited to hydrocarbyl substituent group. One can readily discern and select general groups, specific groups, and/or individual substituted cycloalkane group(s) having a specific number of ring carbons atoms which can be utilized as member of the hydrocarbon group (or a member of the general group of cycloalkane groups).

An aromatic compound is a compound containing a cyclically conjugated double bond system that follows the Hückel (4n+2) rule and contains (4n+2) pi-electrons, where n is an integer from 1 to 5. Aromatic compounds include “arenes” (hydrocarbon aromatic compounds) and “heteroarenes,” also termed “hetarenes” (heteroaromatic compounds formally derived from arenes by replacement of one or more methine (—C═) carbon atoms of the cyclically conjugated double bond system with a trivalent or divalent heteroatoms, in such a way as to maintain the continuous pi-electron system characteristic of an aromatic system and a number of out-of-plane pi-electrons corresponding to the Hückel rule (4n+2). While arene compounds and heteroarene compounds are mutually exclusive members of the group of aromatic compounds, a compound that has both an arene group and a heteroarene group are generally considered a heteroarene compound. Aromatic compounds, arenes, and heteroarenes can be monocyclic (e.g., benzene, toluene, furan, pyridine, methylpyridine) or polycyclic unless otherwise specified. Polycyclic aromatic compounds, arenes, and heteroarenes, include, unless otherwise specified, compounds wherein the aromatic rings can be fused (e.g., naphthalene, benzofuran, and indole), compounds where the aromatic groups can be separate and joined by a bond (e.g., biphenyl or 4-phenylpyridine), or compounds where the aromatic groups are joined by a group containing linking atoms (e.g., carbon—the methylene group in diphenylmethane; oxygen—diphenyl ether; nitrogen—triphenyl amine; among others linking groups). As disclosed herein, the term “substituted” can be used to describe an aromatic group, arene, or heteroarene wherein a non-hydrogen moiety formally replaces a hydrogen in the compound, and is intended to be non-limiting.

An “aromatic group” refers to a generalized group formed by removing one or more hydrogen atoms (as necessary for the particular group and at least one of which is an aromatic ring carbon atom) from an aromatic compound. For a univalent “aromatic group,” the removed hydrogen atom must be from an aromatic ring carbon. For an “aromatic group” formed by removing more than one hydrogen atom from an aromatic compound, at least one hydrogen atom must be from an aromatic hydrocarbon ring carbon. Additionally, an “aromatic group” can have hydrogen atoms removed from the same ring of an aromatic ring or ring system (e.g., phen-1,4-ylene, pyridin-2,3-ylene, naphth-1,2-ylene, and benzofuran-2,3-ylene), hydrogen atoms removed from two different rings of a ring system (e.g., naphth-1,8-ylene and benzofuran-2,7-ylene), or hydrogen atoms removed from two isolated aromatic rings or ring systems (e.g., bis(phen-4-ylene)methane).

An arene is aromatic hydrocarbon, with or without side chains (e.g. benzene, toluene, or xylene, among others). An “aryl group” is a group derived by the formal removal of a hydrogen atom from an aromatic ring carbon of an arene. It should be noted that the arene can contain a single aromatic hydrocarbon ring (e.g., benzene, or toluene), contain fused aromatic rings (e.g., naphthalene or anthracene), and/or contain one or more isolated aromatic rings covalently linked via a bond (e.g., biphenyl) or non-aromatic hydrocarbon group(s) (e.g., diphenylmethane). One example of an “aryl group” is ortho-tolyl (o-tolyl), the structure of which is shown here.

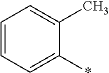 [SMILES: *c1ccccc1C]

Similarly, an “arylene group” refers to a group formed by removing two hydrogen atoms (at least one of which is from an aromatic ring carbon) from an arene. An “arene group” refers to a generalized group formed by removing one or more hydrogen atoms (as necessary for the particular group and at least one of which is an aromatic ring carbon) from an arene. However, if a group contains separate and distinct arene and heteroarene rings or ring systems (e.g., the phenyl and benzofuran moieties in 7-phenylbenzofuran) its classification depends upon the particular ring or ring system from which the hydrogen atom was removed, that is, a substituted arene group if the removed hydrogen came from the aromatic hydrocarbon ring or ring system carbon atom (e.g., the 2 carbon atom in the phenyl group of 6-phenylbenzofuran) and a heteroarene group if the removed hydrogen carbon came from a heteroaromatic ring or ring system carbon atom (e.g., the 2 or 7 carbon atom of the benzofuran group of 6-phenylbenzofuran). It should be noted that according the definitions provided herein, general arene groups (including an aryl group and an arylene group) include those having zero, one, or more than one hydrocarbyl substituent groups located on an aromatic hydrocarbon ring or ring system carbon atom (e.g., a toluene group or a xylene group, among others) and is a member of the group of hydrocarbon groups. However, a phenyl group (or phenylene group) and/or a naphthyl group (or naphthylene group) refer to the specific unsubstituted arene groups. Consequently, a substituted phenyl group or substituted naphthyl group refers to the respective arene group having one or more substituent groups (including halogens, hydrocarbyl groups, or hydrocarboxy groups, among others) located on an aromatic hydrocarbon ring or ring system carbon atom. When the substituted phenyl group and/or substituted naphthyl group is a member of the group of hydrocarbon groups (or a member of the general group of arene groups), each substituent is limited to a hydrocarbyl substituent group. One having ordinary skill in the art can readily discern and select general phenyl and/or naphthyl groups, specific phenyl and/or naphthyl groups, and/or individual substituted phenyl or substituted naphthyl groups which can be utilized as a member of the group of hydrocarbon groups (or a member of the general group of arene groups).

Regarding claim transitional terms or phrases, the transitional term “comprising”, which is synonymous with “including,” “containing,” “having,” or “characterized by,” is inclusive or open-ended and does not exclude additional, unrecited elements or method steps. The transitional phrase “consisting of” excludes any element, step, or ingredient not specified in the claim. The transitional phrase “consisting essentially of” limits the scope of a claim to the specified materials or steps and those that do not materially affect the basic and novel characteristic(s) of the claimed invention. The term “consisting essentially of” occupies a middle ground between closed terms like “consisting of” and fully open terms like “comprising.” Absent an indication to the contrary, when describing a compound or composition “consisting essentially of” is not to be construed as “comprising,” but is intended to describe the recited component that includes materials which do not significantly alter composition or method to which the term is applied. For example, a feedstock consisting essentially of a material A can include impurities typically present in a commercially produced or commercially available sample of the recited compound or composition. When a claim includes different features and/or feature classes (for example, a method step, feedstock features, and/or product features, among other possibilities), the transitional terms comprising, consisting essentially of, and consisting of apply only to feature class to which is utilized and it is possible to have different transitional terms or phrases utilized with different features within a claim. For example a method can comprise several recited steps (and other non-recited steps) but utilize a catalyst system preparation consisting of specific or alternatively consisting essentially of specific steps but utilize a catalyst system comprising recited components and other non-recited components.

While compositions and methods are described in terms of “comprising” (or other broad term) various components and/or steps, the compositions and methods can also be described using narrower terms such as “consist essentially of” or “consist of” the various components and/or steps.

Use of the term “optionally” with respect to any element of a claim is intended to mean that the subject element is required, or alternatively, is not required. Both alternatives are intended to be within the scope of the claim.

The terms “a,” “an,” and “the” are intended, unless specifically indicated otherwise, to include plural alternatives, e.g., at least one. For any particular compound or group disclosed herein, any name or structure presented is intended to encompass all conformational isomers, regioisomers, and stereoisomers that can arise from a particular set of substituents, unless otherwise specified. For example, a general reference to pentane includes n-pentane, 2-methyl-butane, and 2,2-dimethylpropane and a general reference to a butyl group includes an n-butyl group, a sec-butyl group, an iso-butyl group, and t-butyl group. The name or structure also encompasses all enantiomers, diastereomers, and other optical isomers whether in enantiomeric or racemic forms, as well as mixtures of stereoisomers, as would be recognized by a skilled artisan, unless otherwise specified.

The terms “room temperature” or “ambient temperature” are used herein to describe any temperature from 15° C. to 35° C. wherein no external heat or cooling source is directly applied to the reaction vessel. Accordingly, the terms “room temperature” and “ambient temperature” encompass the individual temperatures and any and all ranges, subranges, and combinations of subranges of temperatures from 15° C. to 35° C. wherein no external heating or cooling source is directly applied to the reaction vessel. The term “atmospheric pressure” is used herein to describe an earth air pressure wherein no external pressure modifying means is utilized. Generally, unless practiced at extreme earth altitudes, “atmospheric pressure” is about 1 atmosphere (alternatively, about 14.7 psi or about 101 kPa).

Features within this disclosure that are provided as a minimum values can be alternatively stated as “at least” or “greater than or equal to” any recited minimum value for the feature disclosed herein. Features within this disclosure that are provided as a maximum values can be alternatively stated as “less than or equal to” any recited maximum value for the feature disclosed herein.

Embodiments disclosed herein can provide the materials listed as suitable for satisfying a particular feature of the embodiment delimited by the term “or.” For example, a particular feature of the disclosed subject matter can be disclosed as follows: Feature X can be A, B, or C. It is also contemplated that for each feature the statement can also be phrased as a listing of alternatives such that the statement “Feature X is A, alternatively B, or alternatively C” is also an embodiment of the present disclosure whether or not the statement is explicitly recited.

In an embodiment, the polymers disclosed herein are poly(arylene sulfide) polymers. In an embodiment, the polymer can comprise a poly(arylene sulfide). In other embodiments, the polymer can comprise a poly(phenylene sulfide). Herein, the polymer refers both to a material collected as the product of a polymerization reaction (e.g., a reactor or virgin resin) and a polymeric composition comprising a polymer and one or more additives. In an embodiment, a monomer (e.g., p-dichlorobenzene) can be polymerized using the methodologies disclosed herein to produce a polymer of the type disclosed herein. In an embodiment, the polymer can comprise a homopolymer or a copolymer. It is to be understood that an inconsequential amount of comonomer can be present in the polymers disclosed herein and the polymer still be considered a homopolymer. Herein an inconsequential amount of a comonomer refers to an amount that does not substantively affect the properties of the polymer disclosed herein. For example a comonomer can be present in an amount of less than about 1.0 wt. %, 0.5 wt. %, 0.1 wt. %, or 0.01 wt. %, based on the total weight of polymer.

Generally, poly(arylene sulfide) is a polymer comprising a -(Ar-S)— repeating unit, wherein Ar is an arylene group. Unless otherwise specified the arylene groups of the poly(arylene sulfide) can be substituted or unsubstituted; alternatively, substituted; or alternatively, unsubstituted. Additionally, unless otherwise specified, the poly(arylene sulfide) can include any isomeric relationship of the sulfide linkages in polymer; e.g., when the arylene group is a phenylene group the sulfide linkages can be ortho, meta, para, or combinations thereof.

In an aspect, poly(arylene sulfide) can contain at least 5, 10, 20, 30, 40, 50, 60, 70 mole percent of the -(Ar-S)— unit. In an embodiment, the poly(arylene sulfide) can contain up to 50, 70, 80, 90, 95, 99, or 100 mole percent of the -(Ar-S)— unit. In some embodiments, poly(arylene sulfide) can contain from any minimum mole percent of the -(Ar-S)— unit disclosed herein to any maximum mole percent of the -(Ar-S)— unit disclosed herein; for example, from 5 to 99 mole percent, 30 to 70 mole percent, or 70 to 95 mole percent of the -(Ar-S)— unit. Other ranges for the poly(arylene sulfide) units are readily apparent from the present disclosure. Poly(arylene sulfide) containing less than 100 percent -(Ar-S)— can further comprise units having one or more of the following structures, wherein (*) as used throughout the disclosure represents a continuing portion of a polymer chain or terminal group:

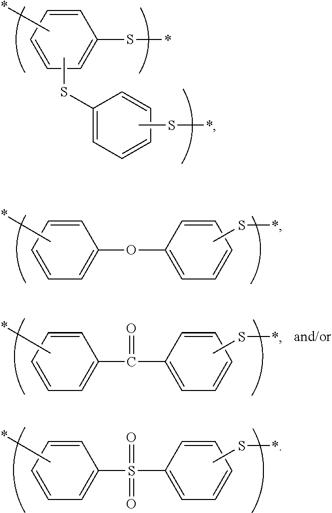

In an embodiment, the arylene sulfide unit can be represented by Formula I.

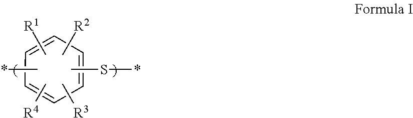

It should be understood, that within the arylene sulfide unit having Formula I, the relationship between the position of the sulfur atom of the arylene sulfide unit and the position where the next arylene sulfide unit can be ortho, meta, para, or any combination thereof. Generally, the identity of R¹, R², R³, and R⁴ are independent of each other and can be any group described herein.

In an embodiment, R¹, R², R³, and R⁴ independently can be hydrogen or a substituent. In some embodiments, each substituent independently can be an organyl group, an organocarboxy group, or an organothio group; alternatively, an organyl group or an organocarboxy group; alternatively, an organyl group or an organothio group; alternatively, an organyl group; alternatively, an organocarboxy group; or alternatively, or an organothio group. In other embodiments, each substituent independently can be a hydrocarbyl group, a hydrocarboxy group, or a hydrocarbylthio group; alternatively, a hydrocarbyl group or a hydrocarboxy group; alternatively, a hydrocarbyl group or a hydrocarbylthio group; alternatively, a hydrocarbyl group; alternatively, a hydrocarboxy group; or alternatively, or a hydrocarbylthio group. In yet other embodiments, each substituent independently can be an alkyl group, an alkoxy group, or an alkylthio group; alternatively, an alkyl group or an alkoxy group; alternatively, an alkyl group or an alkylthio group; alternatively, an alkyl group; alternatively, an alkoxy group; or alternatively, or an alkylthio group.

In an embodiment, each organyl group which can be utilized as R¹, R², R³, and/or R⁴ independently can be a C₁ to C₂₀ organyl group; alternatively, a C₁ to C₁₀ organyl group; or alternatively, a C₁ to C₅ organyl group. In an embodiment, each organocarboxy group which can be utilized as R¹, R², R³, and/or R⁴ independently can be a C₁ to C₂₀ organocarboxy group; alternatively, a C₁ to C₁₀ organocarboxy group; or alternatively, a C₁ to C₅ organocarboxy group. In an embodiment, each organothio group which can be utilized as R¹, R², R³, and/or R⁴ independently can be a C₁ to C₂₀ organothio group; alternatively, a C₁ to C₁₀ organothio group; or alternatively, a C₁ to C₅ organothio group. In an embodiment, each hydrocarbyl group which can be utilized as R¹, R², R³, and/or R⁴ independently can be a C₁ to C₂₀ hydrocarbyl group; alternatively, a C₁ to C₁₀ hydrocarbyl group; or alternatively, a C₁ to C₅ hydrocarbyl group. In an embodiment, each hydrocarboxy group which can be utilized as R¹, R², R³, and/or R⁴ independently can be a C₁ to C₂₀ hydrocarboxy group; alternatively, a C₁ to C₁₀ hydrocarboxy group; or alternatively, a C₁ to C₅ hydrocarboxy group. In an embodiment, each hydrocarbyl group which can be utilized as R¹, R², R³, and/or R⁴ independently can be a C₁ to C₂₀ hydrocarbylthio group; alternatively, a C₁ to C₁₀ hydrocarbylthio group; or alternatively, a C₁ to C₅ hydrocarbylthio group. In an embodiment, each alkyl group which can be utilized as R¹, R², R³, and/or R⁴ independently can be a C₁ to C₂₀ alkyl group; alternatively, a C₁ to C₁₀ alkyl group; or alternatively, a C₁ to C₅ alkyl group. In an embodiment, each alkoxy group which can be utilized as R¹, R², R³, and/or R⁴ independently can be a C₁ to C₂₀ alkoxy group; alternatively, a C₁ to C₁₀ alkoxy group; or alternatively, a C₁ to C₅ alkoxy group. In an embodiment, each alkoxy group which can be utilized as R¹, R², R³, and/or R⁴ independently can be a C₁ to C₂₀ alkylthio group; alternatively, a C₁ to C₁₀ alkylthio group; or alternatively, a C₁ to C₅ alkylthio group.

In some embodiments, each non-hydrogen R¹, R², R³, and/or R⁴ independently can be an alkyl group, a substituted alkyl group, a cycloalkyl group, a substituted cycloalkyl group, an aryl group, a substituted aryl group, an aralkyl group, or a substituted aralkyl group. In other embodiments, each non-hydrogen R¹, R², R³, and/or R⁴ independently can be an alkyl group or a substituted alkyl group; alternatively, a cycloalkyl group or a substituted cycloalkyl group; alternatively, an aryl group or a substituted aryl group; or alternatively, an aralkyl group or a substituted aralkyl group. In yet other embodiments, each non-hydrogen R¹, R², R³, and/or R⁴ independently can be an alkyl group; alternatively, a substituted alkyl group; alternatively, a cycloalkyl group; alternatively, a substituted cycloalkyl group; alternatively, an aryl group; alternatively, a substituted aryl group; alternatively, an aralkyl group; or alternatively, a substituted aralkyl group. Generally, the alkyl group, substituted alkyl group, cycloalkyl group, substituted cycloalkyl group, aryl group, substituted aryl group, aralkyl group, and substituted aralkyl group which can be utilized as R can have the same number of carbon atoms as any organyl group or hydrocarbyl group of which it is a member.

In an embodiment, each non-hydrogen R¹, R², R³, and/or R⁴ independently a methyl group, an ethyl group, a propyl group, a butyl group, a pentyl group, a hexyl group, a heptyl group, an octyl group, a nonyl group, or a decyl group. In some embodiments, each non-hydrogen R¹, R², R³, and/or R⁴ independently can be a methyl group, an ethyl group, a n-propyl group, an iso-propyl group, a n-butyl group, an iso-butyl group, a sec-butyl group, a tert-butyl group, an n-pentyl group, an iso-pentyl group, a sec-pentyl group, or a neopentyl group; alternatively, a methyl group, an ethyl group, an iso-propyl group, a tert-butyl group, or a neopentyl group; alternatively, a methyl group; alternatively, an ethyl group; alternatively, a n-propyl group; alternatively, an iso-propyl group; alternatively, a tert-butyl group; or alternatively, a neopentyl group. In some embodiments, any of the disclosed alkyl groups can be substituted. Substituents for the substituted alkyl group are independently disclosed herein and can be utilized without limitation to further describe the substituted alkyl group which can be utilized as a non-hydrogen R¹, R², R³, and/or R⁴.

In an aspect, each cycloalkyl group (substituted or unsubstituted) which can be utilized as a non-hydrogen R¹, R², R³, and/or R⁴ independently can be a C₄ to C₂₀ cycloalkyl group (substituted or unsubstituted); alternatively, a C₅ to C₁₅ cycloalkyl group (substituted or unsubstituted); or alternatively, a C₅ to C₁₀ cycloalkyl group (substituted or unsubstituted). In an embodiment, each non-hydrogen R¹, R², R³, and/or R⁴ independently can be a cyclobutyl group, a substituted cyclobutyl group, a cyclopentyl group, a substituted cyclopentyl group, a cyclohexyl group, a substituted cyclohexyl group, a cycloheptyl group, a substituted cycloheptyl group, a cyclooctyl group, or a substituted cyclooctyl group. In other embodiments, each non-hydrogen R¹, R², R³, and/or R⁴ independently can be a cyclopentyl group, a substituted cyclopentyl group, a cyclohexyl group, or a substituted cyclohexyl group; alternatively, a cyclopentyl group or a substituted cyclopentyl group; or alternatively, a cyclohexyl group or a substituted cyclohexyl group. In further embodiments, each non-hydrogen R¹, R², R³, and/or R⁴ independently can be a cyclopentyl group; alternatively, a substituted cyclopentyl group; a cyclohexyl group; or alternatively, a substituted cyclohexyl group. Substituents for the substituted cycloalkyl group are independently disclosed herein and can be utilized without limitation to further describe the substituted cycloalkyl group which can be utilized as a non-hydrogen R group. Substituents for the substituted cycloalkyl groups (general or specific) are independently disclosed herein and can be utilized without limitation to further describe the substituted cycloalkyl groups which can be utilized as a non-hydrogen R¹, R², R³, and/or R⁴.

In an aspect, the aryl group (substituted or unsubstituted) which can be utilized as a non-hydrogen R¹, R², R³, and/or R⁴ independently can be a C₆-C₂₀ aryl group (substituted or unsubstituted); alternatively, a C₆-C₁₅ aryl group (substituted or unsubstituted); or alternatively, a C₆-C₁₀ aryl group (substituted or unsubstituted). In an embodiment, each R¹, R², R³, and/or R⁴ independently can be a phenyl group, a substituted phenyl group, a naphthyl group, or a substituted naphthyl group. In an embodiment, each R¹, R², R³, and/or R⁴ independently can be a phenyl group or a substituted phenyl group; alternatively, a naphthyl group or a substituted naphthyl group; alternatively, a phenyl group or a naphthyl group; or alternatively, a substituted phenyl group or a substituted naphthyl group.

In an embodiment, each substituted phenyl group which can be utilized as a non-hydrogen R¹, R², R³, and/or R⁴ independently can be a 2-substituted phenyl group, a 3-substituted phenyl group, a 4-substituted phenyl group, a 2,4-disubstituted phenyl group, a 2,6-disubstituted phenyl group, a 3,5-disubstituted phenyl group, or a 2,4,6-trisubstituted phenyl group. In other embodiments, each substituted phenyl group which can be utilized as a non-hydrogen R¹, R², R³, and/or R⁴ independently can be a 2-substituted phenyl group, a 4-substituted phenyl group, a 2,4-disubstituted phenyl group, or a 2,6-disubstituted phenyl group; alternatively, a 3-substituted phenyl group or a 3,5-disubstituted phenyl group; alternatively, a 2-substituted phenyl group or a 4-substituted phenyl group; alternatively, a 2,4-disubstituted phenyl group or a 2,6-disubstituted phenyl group; alternatively, a 2-substituted phenyl group; alternatively, a 3-substituted phenyl group; alternatively, a 4-substituted phenyl group; alternatively, a 2,4-disubstituted phenyl group; alternatively, a 2,6-disubstituted phenyl group; alternatively, 3,5-disubstituted phenyl group; or alternatively, a 2,4,6-trisubstituted phenyl group. Substituents for the substituted phenyl groups (general or specific) are independently disclosed herein and can be utilized without limitation to further describe the substituted phenyl groups which can be utilized as a non-hydrogen R¹, R², R³, and/or R⁴.

Nonlimiting examples of suitable poly(arylene sulfide) polymers suitable for use in this disclosure include poly(2,4-toluene sulfide), poly(4,4′-biphenylene sulfide), poly(para-phenylene sulfide), poly(ortho-phenylene sulfide), poly(meta-phenylene sulfide), poly(xylene sulfide), poly(ethylisopropylphenylene sulfide), poly(tetramethylphenylene sulfide), poly(butylcyclohexylphenylene sulfide), poly(hexyldodecylphenylene sulfide), poly(octadecyl-phenylene sulfide), poly(phenylphenylene sulfide), poly(tolylphenylene sulfide), poly(benzyl-phenylene sulfide), poly[octyl-4-(3-methylcyclopentyl)phenylene sulfide], and any combination thereof.

In an embodiment the poly(arylene sulfide) polymer comprises poly(phenylene sulfide) or PPS. In an aspect, PPS is a polymer comprising at least about 70, 80, 90, or 95 mole percent para-phenylene sulfide units. In another embodiment, the poly(arylene sulfide) can contain up to about 50, 70, 80, 90, 95, or 99 mole percent para-phenylene sulfide units. In some embodiments, PPS can contain from any minimum mole percent of the para-phenylene sulfide unit disclosed herein to any maximum mole percent of the para-phenylene sulfide unit disclosed herein; for example, from about 70 to about 99 mole percent, alternatively, from about 70 to about 95 mole percent, or alternatively, from about 80 to about 95 mole percent of the -(Ar-S)-unit. Other suitable ranges for the para-phenylene sulfide units will be readily apparent to one of skill in the art with the help of this disclosure. The structure for the para-phenylene sulfide unit can be represented by Formula II.

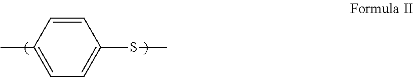

In an embodiment, PPS can comprise up to about 30, 20, 10, or 5 mole percent of one or more units selected from ortho-phenylene sulfide groups, meta-phenylene sulfide groups, substituted phenylene sulfide groups, phenylene sulfone groups, substituted phenylene sulfide groups, or groups having the following structures:

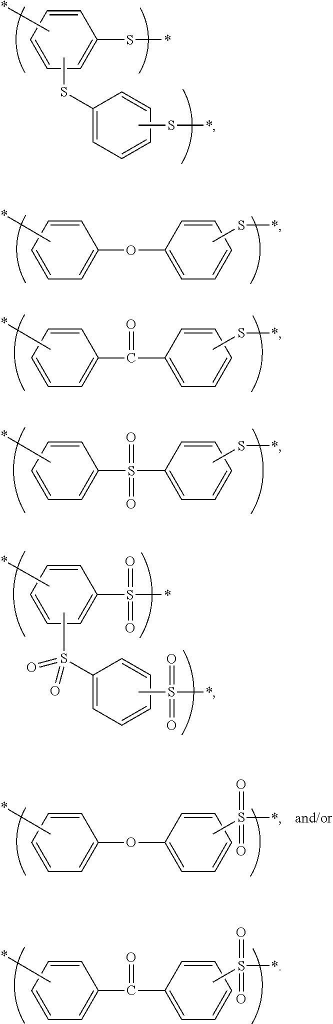

In other embodiments, PPS can comprise up to about 30, 20, 10, or 5 mole percent of units having one or more of the following structures:

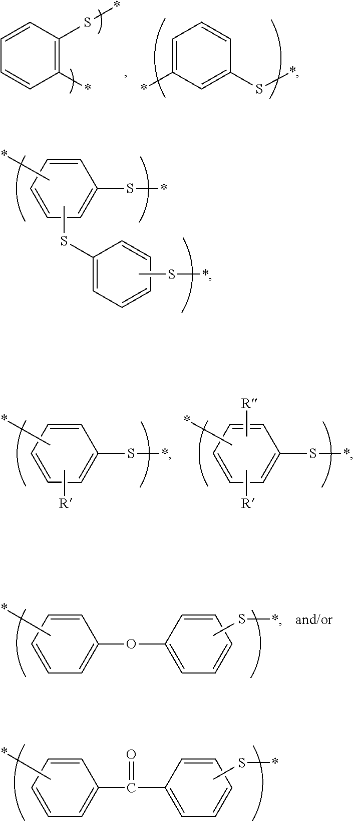

wherein R′ and R″ can be independently selected from any arylene substituent group disclosed herein for a poly(arylene sulfide). In other embodiments, PPS can comprise up to about 30, 20, 10, or 5 mole percent of units having one or more of the following structures:

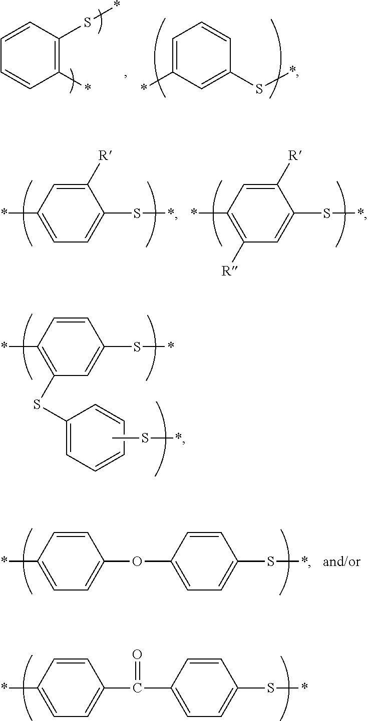

wherein R′ and R″ can be independently selected from any arylene substituent group disclosed herein for a poly(arylene sulfide). In other embodiments, PPS can comprise up to about 30, 20, 10, or 5 mole percent of units having one or more of the following structures:

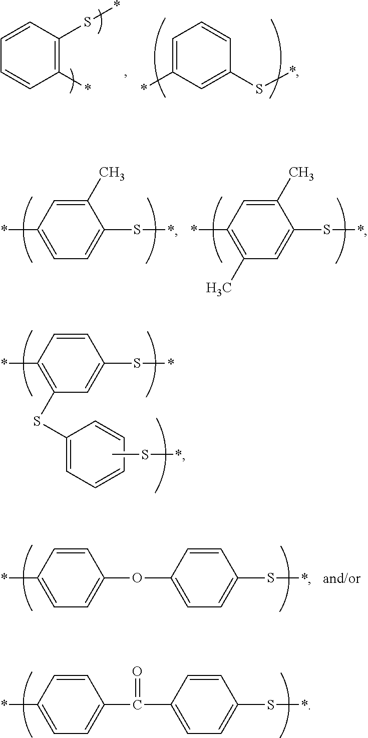

The PPS molecular structure can readily form a thermally stable crystalline lattice, giving PPS a semi-crystalline morphology with a high crystalline melting point ranging from about 265° C. to about 315° C. Because of its molecular structure, PPS also can tend to char during combustion, making the material inherently flame resistant. Further, PPS can not typically dissolve in solvents at temperatures below about 200° C.

PPS is manufactured and sold under the trade name Ryton® PPS by Chevron Phillips Chemical Company LP of The Woodlands, Tex. Other sources of poly(phenylene sulfide) include Ticona, Toray, and Dainippon Ink and Chemicals, Incorporated, among others.

Generally, a poly(arylene sulfide) can be produced by contacting at least one halogenated aromatic compound having two halogens, a sulfur compound, and a polar organic compound to form the poly(arylene sulfide). In an embodiment, the process to produce the poly(arylene sulfide) can further comprise recovering the poly(arylene sulfide). In some embodiments, the polyarylene sulfide can be formed under polymerization conditions capable of producing the poly(arylene sulfide). In an embodiment, the poly(arylene sulfide) can be produced in the presence of a halogenated aromatic compound having greater than two halogen atoms (e.g., 1,2,4,-trichlorobenzene, among others).

Similarly, PPS can be produced by contacting at least one para-dihalobenzene compound, a sulfur compound, and a polar organic compound to form the PPS. In an embodiment, the process to produce the PPS can further comprise recovering the PPS. In some embodiments, the PPS can be formed under polymerization conditions capable of forming the PPS. When producing PPS, other dihaloaromatic compounds can also be present so long as the produced PPS conforms to the PPS desired features. For example, in an embodiment, the PPS can be prepared utilizing substituted para-dihalobenzene compounds and/or halogenated aromatic compounds having greater than two halogen atoms (e.g., 1,2,4-trichlorobenzene or substituted or a substituted 1,2,4-trichlorobenzene, among others). Methods of PPS production are described in more detail in U.S. Pat. Nos. 3,919,177; 3,354,129; 4,038,261; 4,038,262; 4,038,263; 4,064,114; 4,116,947; 4,282,347; 4,350,810; and 4,808,694; each of which is incorporated by reference herein in its entirety.

In an embodiment, halogenated aromatic compounds having two halogens which can be employed to produce the poly(arylene sulfide) can be represented by Formula III.

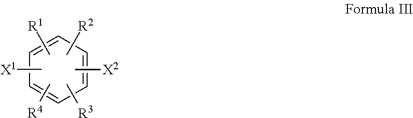

In an embodiment, X¹ and X² independently can be a halogen. In some embodiments, each X¹ and X² independently can be fluorine, chlorine, bromine, iodine; alternatively, chlorine, bromine, or iodine; alternatively, chlorine; alternatively, bromine; or alternatively, iodine. R¹, R², R³, and R⁴ have been described previously herein for the poly(arylene sulfide) having Formula I. Any aspect and/or embodiment of these R¹, R², R³, and R⁴ descriptions can be utilized without limitation to describe the halogenated aromatic compounds having two halogens represented by Formula III. It should be understood, that for producing poly(arylene sulfide)s, the relationship between the position of the halogens X¹ and X² can be ortho, meta, para, or any combination thereof; alternatively, ortho; alternatively, meta; or alternatively, para. Examples of halogenated aromatic compounds having two halogens that can be utilized to produce a poly(arylene sulfide) can include, but not limited to, dichlorobenzene (ortho, meta, and/or para), dibromobenzene (ortho, meta, and/or para), diiodobenzene (ortho, meta, and/or para), chlorobromobenzene (ortho, meta, and/or para), chloroiodobenzene (ortho, meta, and/or para), bromoiodobenzene (ortho, meta, and/or para), dichlorotoluene, dichloroxylene, ethylisopropyldibromobenzene, tetramethyldichlorobenzene, butylcyclohexyldibromobenzene, hexyldodecyldichlorobenzene, octadecyldiidobenzene, phenylchlorobromobenzene, tolyldibromobenzene, benzyldichloro-benzene, octylmethylcyclopentyldichlorobenzene, or any combination thereof.

The para-dihalobenzene compound which can be utilized to produce poly(phenylene sulfide) can be any para-dihalobenzene compound. In an embodiment, para-dihalobenzenes that can be used in the synthesis of PPS can be, comprise, or consist essentially of, p-dichlorobenzene, p-dibromobenzene, p-diiodobenzene, 1-chloro-4-bromobenzene, 1-chloro-4-iodobenzene, 1-bromo-4-iodobenzene, or any combination thereof. In some embodiments, the para-dihalobenzene that can be used in the synthesis of PPS can be, comprise, or consist essentially of, p-dichlorobenzene.

In some embodiments, the synthesis of the PPS can further include 2,5-dichlorotoluene, 2,5-dichloro-p-xylene, 1-ethyl-4-isopropyl-2,5-dibromobenzene, 1,2,4,5-tetramethyl-3,6-dichlorobenzene, 1-butyl-4-cyclohexyl-2,5-dibromobenzene, 1-hexyl-3-dodecyl-2,5-dichlorobenzene, 1-octadecyl-2,5-diidobenzene, 1-phenyl-2-chloro-5-bromobenzene, 1-(p-tolyl)-2,5-dibromobenzene, 1-benzyl-2,5-dichlorobenzene, 1-octyl-4-(3-methylcyclopentyl)-2,5-dichlorobenzene, or combinations thereof.

Without wishing to be limited by theory, sulfur sources which can be employed in the synthesis of the poly(arylene sulfide) can include thiosulfates, thioureas, thioamides, elemental sulfur, thiocarbamates, metal disulfides and oxysulfides, thiocarbonates, organic mercaptans, organic mercaptides, organic sulfides, alkali metal sulfides and bisulfides, hydrogen sulfide, or any combination thereof. In an embodiment, an alkali metal sulfide can be used as the sulfur source. Alkali metal sulfides suitable for use in the present disclosure can be, comprise, or consist essentially of, lithium sulfide, sodium sulfide, potassium sulfide, rubidium sulfide, cesium sulfide, or any combination thereof. In some embodiments, the alkali metal sulfides that can be employed in the synthesis of the poly(arylene sulfide) can be an alkali metal sulfide hydrate or an aqueous alkali metal sulfide solution; alternatively, an alkali metal sulfide hydrate; or alternatively, an aqueous alkali metal sulfide solution. Aqueous alkali metal sulfide solution can be prepared by any suitable methodology. In an embodiment, the aqueous alkali metal sulfide solution can be prepared by the reaction of an alkali metal hydroxide with an alkali metal bisulfide in water; or alternatively, prepared by the reaction of an alkali metal hydroxide with hydrogen sulfide (H₂S) in water. Other sulfur sources suitable for use in the present disclosure are described in more detail in U.S. Pat. No. 3,919,177, which is incorporated by reference herein in its entirety.

In an embodiment, a process for the preparation of poly(arylene sulfide) can utilize a sulfur source which can be, comprise, or consist essentially of, an alkali metal bisulfide. In such embodiments, a reaction mixture for preparation of the poly(arylene sulfide) can comprise a base. In such embodiments, alkali metal hydroxides, such as sodium hydroxide (NaOH) can be utilized. In such embodiments, it can be desirable to reduce the alkalinity of the reaction mixture prior to termination of the polymerization reaction. Without wishing to be limited by theory, a reduction in alkalinity of the reaction mixture can result in the formation of a reduced amount of ash-causing polymer structures. The alkalinity of the reaction mixture can be reduced by any suitable methodology, for example by the addition of an acidic solution prior to termination of the polymerization reaction.

In an embodiment, the sulfur source suitable for use in the production of poly(arylene sulfide) can be prepared by combining sodium hydrosulfide (NaSH) and sodium hydroxide (NaOH) in an aqueous solution followed by dehydration (or alternatively, by combining an alkali metal hydroxide with hydrogen sulfide (H₂S)). The production of Na₂S in this manner can be considered to be an equilibrium between Na₂S, water (H₂O), NaSH, and NaOH according to the following equation.

Na₂S+H₂O⇄NaSH+NaOH

The resulting sulfur source can be referred to as sodium sulfide (Na₂S). In another embodiment, the production of Na₂S can be performed in the presence of the polar organic solvent, e.g., N-methyl-2-pyrrolidone (NMP), among others disclosed herein. Without being limited to theory, when the sulfur compound (e.g., sodium sulfide) is prepared by reacting NaSH with NaOH in the presence of water and N-methyl-2-pyrrolidone, the N-methyl-2-pyrrolidone can also react with the sodium hydroxide (e.g., aqueous sodium hydroxide) to produce a mixture containing sodium hydrosulfide and sodium N-methyl-4-aminobutanoate (SMAB). Stoichiometrically, the overall reaction equilibrium can appear to follow the equation:

NMP+Na₂S+H₂O⇄CH₃NH₂CH₂CH₂CH₂CO₂Na (SMAB)+NaSH

However, it should be noted that this equation is a simplification and, in actuality, the equilibrium between Na₂S, H₂O, NaOH, and NaSH, and the water-mediated ring opening of NMP by sodium hydroxide can be significantly more complex.

The polar organic compound which can be utilized in the preparation of a poly(arylene sulfide) can comprise a polar organic compound which can function to keep the dihaloaromatic compounds, sulfur source, and growing poly(arylene sulfide) in solution during the polymerization. In an aspect, the polar organic compound can be, comprise, or consist essentially of, an amide, a lactam, a sulfone, or any combinations thereof; alternatively, an amide; alternatively, a lactam; or alternatively, a sulfone. In an embodiment, the polar organic compound can be, comprise, or consist essentially of, hexamethylphosphoramide, tetramethylurea, N,N-ethylenedipyrrolidone, N-methyl-2-pyrrolidone, pyrrolidone, caprolactam, N-ethylcaprolactam, sulfolane, N,N′-dimethylacetamide, 1,3-dimethyl-2-imidazolidinone, low molecular weight polyamides, or combinations thereof. In an embodiment, the polar organic compound can be, comprise, or consist essentially of, N-methyl-2-pyrrolidone. Additional polar organic compounds suitable for use in the present disclosure are described in more detail in D. R. Fahey and J. F. Geibel, Polymeric Materials Encyclopedia, Vol. 8, (Boca Raton, CRC Press, 1996), pages 6506-6515, which is incorporated by reference herein in its entirety.

In an embodiment, processes for the preparation of a poly(arylene sulfide) can employ one or more additional reagents. For example, molecular weight modifying or enhancing agents such as alkali metal carboxylates, lithium halides, or water can be added or produced during polymerization. In an embodiment, a reaction mixture for preparation of a poly(arylene sulfide) can further comprise an alkali metal carboxylate.

Alkali metal carboxylates which can be employed include, without limitation, those having general formula R′CO₂M where R′ can be a C₁ to C₂₀ hydrocarbyl group, a C₁ to C₂₀ hydrocarbyl group, or a C₁ to C₅ hydrocarbyl group. In some embodiments, R′ can be an alkyl group, a cycloalkyl group, an aryl group, aralkyl group; or alternatively, an alkyl group. Alkyl groups, cycloalkyl groups, aryl groups, aralkyl groups are disclosed herein (e.g., as options for R¹, R², R³, and R⁴ or a substituent groups). These alkyl groups, cycloalkyl groups, aryl groups, aralkyl groups can be utilized without limitation to further describe R′ of the alkali metal carboxylates having the formula R′CO₂M. In an embodiment, M can be an alkali metal. In some embodiments, the alkali metal can be, comprise, or consist essentially of, lithium, sodium, potassium, rubidium, or cesium; alternatively, lithium; alternatively, sodium; or alternatively, potassium. The alkali metal carboxylate can be employed as a hydrate; or alternatively, as a solution or dispersion in water. In an embodiment, the alkali metal carboxylate can be, comprise, or consist essentially of, sodium acetate (NaOAc or NaC₂H₃O₂).

General conditions for the production of poly(arylene sulfides) are generally described in U.S. Pat. Nos. 5,023,315; 5,245,000; 5,438,115; and 5,929,203; each of which is incorporated by reference herein in its entirety. Although specific mention can be made in this disclosure and the disclosures incorporated by reference herein to material produced using the “quench” termination process, it is contemplated that other processes (e.g., “flash” termination process) can be employed for the preparation of a poly(arylene sulfide) (e.g., PPS). It is contemplated that a poly(arylene sulfide) obtained from a process other than the quench termination process can be suitably employed in the methods and compositions of this disclosure.

Generally, the ratio of reactants employed in the polymerization process to produce a poly(arylene sulfide) can vary widely. However, the typical equivalent ratio of the halogenated aromatic compound having two halogens to sulfur compound can be in the range of from about 0.8 to about 2; alternatively, from about 0.9 to about 1.5; or alternatively, from about 0.95 to about 1.3. The amount of polyhalo-substituted aromatic compound optionally employed as a reactant can be any amount to achieve the desired degree of branching to give the desired poly(arylene sulfide) melt flow. Generally, up to about 0.02 moles of polyhalo-substituted aromatic compound per mole of halogenated aromatic compound having two halogens can be employed. If an alkali metal carboxylate is employed as a molecular weight modifying agent, the mole ratio of alkali metal carboxylate to dihaloaromatic compound(s) can be within the range of from about 0.02 to about 4; alternatively, from about 0.05 to about 3; or alternatively, from about 0.1 to about 2.

The amount of polar organic compound employed in the process to prepare the poly(arylene sulfide) can vary over a wide range during the polymerization. However, the molar ratio of polar organic compound to the sulfur compound is typically within the range of from about 1 to about 10. If a base, such as sodium hydroxide, is contacted with the polymerization reaction mixture, the molar ratio is generally in the range of from about 0.5 to about 4 moles per mole of sulfur compound.

The components of the reaction mixture can be contacted with each other in any order. Some of the water, which can be introduced with the reactants, can be removed prior to polymerization. In some instances, the water can be removed in a dehydration process. For example, in instances where a significant amount of water is present (e.g., more than about 0.3 moles of water per mole of sulfur compound) water can be removed in a dehydration process. The temperature at which the polymerization can be conducted can be within the range of from about 170° C. (347° F.) to about 450° C. (617° F.); or alternatively, within the range of from about 200° C. (392° F.) to about 285° C. (545° F.). The reaction time can vary widely, depending, in part, on the reaction temperature, but is generally within the range of from about 10 minutes to about 3 days; or alternatively, within a range of from about 1 hour to about 8 hours. The reactor pressure need be only sufficient to maintain the polymerization reaction mixture substantially in the liquid phase. Such pressure will can be in the range of from about 0 psig to about 400 psig; alternatively, in the range of from about 30 psig to about 300 psig; or alternatively, in the range of from about 100 psig to about 250 psig.

The polymerization can be terminated by cooling the reaction mixture (removing heat) to a temperature below that at which substantial polymerization takes place. In some instances the cooling of the reaction mixture also begins the process to recover the poly(arylene sulfide) as the poly(arylene sulfide) can precipitate from solution at temperatures less than about 235° C. Depending upon the polymerization features (temperature, solvent(s), and water quantity, among other features) and the methods employed to cool the reaction mixture, the poly(arylene sulfide) can begin to precipitate from the reaction solution at a temperature ranging from about 235° C. to about 185° C. Generally, poly(arylene sulfide) precipitation can impede further polymerization.

The poly(arylene sulfide) reaction mixture can be cooled using a variety of methods. In an embodiment, the polymerization can be terminated by the flash evaporation of the solvent (e.g., the polar organic compound, water, or a combination thereof) from the poly(arylene sulfide) reaction mixture. Processes for preparing poly(arylene sulfide) utilizing solvent flash evaporation to terminate the reaction can be referred to as a flash termination process. In other embodiments, the polymerization can be terminated by adding a liquid comprising, or consisting essentially of, 1) water, 2) polar organic compound, or 3) a combination of water and polar organic compound (alternatively water; or alternatively, polar organic compound) to the poly(arylene sulfide) reaction mixture and cooling the poly(arylene sulfide) reaction mixture. In yet other embodiments, the polymerization can be terminated by adding a solvent(s) other than water or the polar organic compound to the poly(arylene sulfide) reaction mixture and cooling the poly(arylene sulfide) reaction mixture. Processes for preparing poly(arylene sulfide) which utilize the addition of water, polar organic compound, and/or other solvent(s) to terminate the reaction can be referred to as a quench termination process. The cooling of the reaction mixture can be facilitated by the use of reactor jackets or coil. Another method for terminating the polymerization can include contacting the reaction mixture with a polymerization inhibiting compound. It should be noted that termination of the polymerization does not imply that complete reaction of the polymerization components has occurred. Moreover, termination of the polymerization is not meant to imply that no further polymerization of the reactants can take place. Generally, for economic reasons, termination (and poly(arylene sulfide) recovery) can be initiated at a time when polymerization is substantially complete or when further reaction would not result in a significant increase in polymer molecular weight.

Once the poly(arylene sulfide) has precipitated from solution, a particulate poly(arylene sulfide) can be recovered from the reaction mixture slurry by any process capable of separating a solid precipitate from a liquid. For purposes of the disclosure herein, the recovered particulate poly(arylene sulfide) will be referred to as “raw particulate poly(arylene sulfide) polymer,” “raw particulate poly(arylene sulfide),” “raw poly(arylene sulfide) polymer,” or simply “raw poly(arylene sulfide),” (e.g., “raw PPS”). It should be noted that the process to produce the poly(arylene sulfide) can form a by-product alkali metal halide. The by-product alkali metal halide can be removed during process steps utilized to recover the raw poly(arylene sulfide) (e.g., raw PPS). Procedures which can be utilized to recover the raw poly(arylene sulfide) from the reaction mixture slurry can include, but are not limited to, i) filtration, ii) washing the raw poly(arylene sulfide) with a liquid (e.g., water or aqueous solution), or iii) dilution of the reaction mixture with liquid (e.g., water or aqueous solution) followed by filtration and washing the raw poly(arylene sulfide) with a liquid (e.g., water or aqueous solution). For example, in a non-limiting embodiment, the reaction mixture slurry can be filtered to recover the raw poly(arylene sulfide) (e.g., the raw PPS) polymer (containing poly(arylene sulfide) or PPS, and by-product alkali metal halide), which can be slurried in a liquid (e.g., water or aqueous solution) and subsequently filtered to remove the alkali metal halide by-product (and/or other liquid, e.g., water, soluble impurities). Generally, the steps of slurring the raw poly(arylene sulfide) with a liquid followed by filtration to recover the raw poly(arylene sulfide) can occur as many times as necessary to obtain a desired level of purity of the raw poly(arylene sulfide).

In an embodiment, the polar organic compound can also be recovered at the end of the polymerization process. For example, if the raw poly(arylene sulfide) is being recovered by filtration, the filtrate (e.g., the liquid phase in the filtration process) can comprise the polar organic compound. Such filtrate can be subjected to a liquid-liquid extraction process for the recovery of the polar organic compound. For example, when the polar organic compound is NMP, the filtrate can be treated with an alcohol (e.g., 1-hexanol), and the NMP can be recovered in the phase comprising the alcohol (e.g., 1-hexanol). The recovered NMP can be recycled/reused in a subsequent polymerization process for the production of poly(arylene sulfide) (e.g., PPS).

The raw poly(arylene sulfide) can undergo post recovery processing. For example, the raw poly(arylene sulfide) can be treated with an aqueous acid solution and/or can be treated with an aqueous metal cation solution, to yield treated poly(arylene sulfide) (e.g., acid treated poly(arylene sulfide), metal cation treated poly(arylene sulfide)). Additionally, the raw poly(arylene sulfide) can be dried to remove liquid adhering to the raw particulate poly(arylene sulfide) (e.g., raw PPS) polymer. Generally, the raw poly(arylene sulfide) which can undergo post recovery processing can be i) the raw poly(arylene sulfide) recovered from the reaction mixture or ii) the raw poly(arylene sulfide) (e.g., raw PPS) which has been washed with a liquid (e.g., water) and filtered to remove the alkali metal halide by-product (and/or other liquid soluble impurities). The raw poly(arylene sulfide) which can undergo post recovery processing can either be liquid wet or dry; alternatively, liquid wet; or alternatively, dry.

Acid treatment can comprise a) contacting the raw poly(arylene sulfide) with water to form a poly(arylene sulfide) slurry, b) contacting the poly(arylene sulfide) slurry with an acidic compound to form an acidic mixture, c) heating the acidic mixture in substantial absence of a gaseous oxidizing atmosphere to an elevated temperature below the melting point of the poly(arylene sulfide), and d) recovering an acid treated poly(arylene sulfide) (e.g., an acid treated PPS); or alternatively, a) contacting the raw poly(arylene sulfide) with aqueous solution comprising an acidic compound to form an acidic mixture, b) heating the acidic mixture in substantial absence of a gaseous oxidizing atmosphere to an elevated temperature below the melting point of the poly(arylene sulfide), and c) recovering an acid treated poly(arylene sulfide) (e.g., acid treated PPS). The acidic compound can be any organic acid or inorganic acid which is water soluble under the conditions of the acid treatment; alternatively, an organic acid which is water soluble under the conditions of the acid treatment; or alternatively, an inorganic acid which is water soluble under the conditions of the acid treatment. Generally, the organic acid which can be utilized in the acid treatment can be any organic acid which is water soluble under the conditions of the acid treatment. In an embodiment, the organic acid which can be utilized in the acid treatment process can comprise, or consist essentially of, a C₁ to C₁₅ carboxylic acid; alternatively, a C₁ to C₁₀ carboxylic acid; or alternatively, a C₁ to C₅ carboxylic acid. In an embodiment, the organic acid which can be utilized in the acid treatment process can comprise, or consist essentially of, acetic acid, formic acid, oxalic acid, fumaric acid, and monopotassium phthalic acid; alternatively, acetic acid; alternatively, formic acid; alternatively, oxalic acid; or alternatively, fumaric acid. Inorganic acids which can be utilized in the acid treatment process can comprise, or consist essentially of, hydrochloric acid, monoammonium phosphate, sulfuric acid, phosphoric acid, boric acid, nitric acid, sodium dihydrogen phosphate, ammonium dihydrogen phosphate, carbonic acid, and sulfurous acid; alternatively, hydrochloric acid; alternatively, sulfuric acid; alternatively, phosphoric acid; alternatively, boric acid; or alternatively, nitric acid. The amount of the acidic compound present in the mixture (e.g., acidic mixture) can range from 0.01 wt. % to 10 wt. %, from 0.025 wt. % to 5 wt. %, or from 0.075 wt. % to 1 wt. % based on total amount of water in the mixture (e.g., acidic mixture). The amount of poly(arylene sulfide) present in the mixture (e.g., acidic mixture) can range from about 1 wt. % to about 50 wt. %, from about 5 wt. % to about 40 wt. %, or from about 10 wt. % to about 30 wt. %, based upon the total weight of the mixture (e.g., acidic mixture). Generally, the elevated temperature below the melting point of the poly(arylene sulfide) can range from about 165° C. to about 10° C., from about 150° C. to about 15° C., or from about 125° C. to about 20° C. below the melting point of the poly(arylene sulfide); or alternatively, can range from about 175° C. to about 275° C., or from about 200° C. to about 250° C. Additional features of the acid treatment process are described in more detail in U.S. Pat. No. 4,801,644, which is incorporated by reference herein in its entirety.

Generally, the metal cation treatment can comprise a) contacting the raw poly(arylene sulfide) with water to form a poly(arylene sulfide) slurry, b) contacting the poly(arylene sulfide) slurry with a Group 1 or Group 2 metal compound to form a metal cation mixture, c) heating the metal cation mixture in substantial absence of a gaseous oxidizing atmosphere to an elevated temperature below the melting point of the poly(arylene sulfide), and d) recovering a metal cation treated poly(arylene sulfide) (e.g., metal cation treated PPS); or alternatively, a) contacting the poly(arylene sulfide) with an aqueous solution comprising a Group 1 or Group 2 metal compound to form a metal cation mixture, b) heating the metal cation mixture in substantial absence of a gaseous oxidizing atmosphere to an elevated temperature below the melting point of the poly(arylene sulfide), and c) recovering a metal cation treated poly(arylene sulfide) (e.g., metal cation treated PPS). The Group 1 or Group 2 metal compound can be any organic Group 1 or Group 2 metal compound or inorganic Group 1 or Group 2 metal compound which is water soluble under the conditions of the metal cation treatment; alternatively, an organic Group 1 or Group 2 metal compound which is water soluble under the conditions of the metal cation treatment; or alternatively, an inorganic Group 1 or Group 2 metal compound which is water soluble under the conditions of the metal cation treatment. Organic Group 1 or Group 2 metal compounds which can be utilized in the metal cation treatment process can comprise, or consist essentially of, a Group 1 or Group 2 metal C₁ to C₁₅ carboxylate; alternatively, a Group 1 or Group 2 metal C₁ to C₁₀ carboxylate; or alternatively, a Group 1 or Group 2 metal C₁ to C₅ carboxylate (e.g., formate, acetate). Inorganic Group 1 or Group 2 metal compounds which can be utilized in the metal cation treatment process can comprise, or consist essentially of, a Group 1 or Group 2 metal oxide or hydroxide (e.g., calcium oxide or calcium hydroxide). The amount of the Group 1 or Group 2 metal compound present in the mixture (e.g., metal cation mixture) can range from about 50 ppm to about 10,000 ppm, from about 75 ppm to about 7,500 ppm, or from about 100 ppm to about 5,000 ppm. Generally, the amount of the Group 1 or Group 2 metal compound is by the total weight of the mixture (e.g., metal cation mixture). The amount of poly(arylene sulfide) present in the mixture (e.g., metal cation mixture) can range from about 10 wt. % to about 60 wt. %, from about 15 wt. % to about 55 wt. %, or from about 20 wt. % to about 50 wt. %, based upon the total weight of the mixture (e.g., metal cation mixture). Generally, the elevated temperature below the melting point of the poly(arylene sulfide) can range from about 165° C. to about 10° C., from about 150° C. to about 15° C., or from about 125° C. to about 20° C. below the melting point of the poly(arylene sulfide); or alternatively, can range from about 125° C. to about 275° C., or from about 150° C. to about 250° C. Additional features of the acid treatment process are provided in EP patent publication 0103279 A1, which is incorporated by reference herein in its entirety.

Once the poly(arylene sulfide) has been acid treated and/or metal cation treated, the acid treated and/or metal cation treated poly(arylene sulfide) can be recovered, to yield a recovered poly(arylene sulfide) polymer. Generally, the process/steps for recovering the acid treated and/or metal cation treated poly(arylene sulfide) can be the same steps as those for recovering and/or isolating the raw poly(arylene sulfide) from the reaction mixture.

Once the poly(arylene sulfide) has been recovered (either in raw, acid treated, metal cation treated, or acid treated and metal cation treated form), the recovered poly(arylene sulfide) (e.g., recovered PPS) can be dried and optionally cured.

Generally, the poly(arylene sulfide) (e.g., recovered poly(arylene sulfide)) drying process can be performed at any temperature which can substantially dry the poly(arylene sulfide), to yield a dried poly(arylene sulfide) polymer. The drying process should result in substantially no oxidative curing of the poly(arylene sulfide). For example, if the drying process is conducted at a temperature of or above about 100° C., the drying should be conducted in a substantially non-oxidizing atmosphere (e.g., in a substantially oxygen free atmosphere or at a pressure less than atmospheric pressure, for example under vacuum). When the drying process is conducted at a temperature below about 100° C., the drying process can be facilitated by performing the drying at a pressure less than atmospheric pressure so the liquid component can be vaporized from the poly(arylene sulfide). When the poly(arylene sulfide) drying is performed below about 100° C., the presence of a gaseous oxidizing atmosphere will generally not result in a detectable curing of the poly(arylene sulfide). Generally, air is considered to be a gaseous oxidizing atmosphere.

Poly(arylene sulfide) can be cured by subjecting the poly(arylene sulfide) to an elevated temperature, below its melting point, in the presence of gaseous oxidizing atmosphere, thereby forming cured poly(arylene sulfide) (e.g., cured PPS). Any suitable gaseous oxidizing atmosphere can be used. For example, suitable gaseous oxidizing atmospheres include, but are not limited to, oxygen, any mixture of oxygen and an inert gas (e.g., nitrogen), or air; or alternatively air. The curing temperature can range from about 1° C. to about 130° C. below the melting point of the poly(arylene sulfide), from about 10° C. to about 110° C. below the melting point of the poly(arylene sulfide), or from about 30° C. to about 85° C. below the melting point of the poly(arylene sulfide). Agents that affect curing, such as peroxides, accelerants, and/or inhibitors, can be incorporated into the poly(arylene sulfide).

In an aspect, the poly(arylene sulfide) polymer described herein can further comprise one or more additives. In an embodiment, the poly(arylene sulfide) polymer can ultimately be used or blended in a compounding process, for example, with various additives, such as polymers, fillers, fibers, conventional reinforcing materials, pigments, nucleating agents, antioxidants, ultraviolet (UV) stabilizers (e.g., UV absorbers), lubricants, fire retardants, heat stabilizers, carbon black, plasticizers, corrosion inhibitors, mold release agents, pigments, titanium dioxide. clay, mica, processing aids, adhesives, tackifiers, and the like, or combinations thereof.

In an embodiment, fillers which can be utilized include, but are not limited to, mineral fillers, inorganic fillers, or organic fillers, or mixtures thereof. In some embodiments, the filler can comprise, or consist essentially of, a mineral filler; alternatively, an inorganic filler; or alternatively, an organic filler. In an embodiment, mineral fillers which can be utilized include, but are not limited to, conventional glass fibers, milled fibers, glass beads, asbestos, wollastonite, hydrotalcite, fiberglass, mica, talc, clay, calcium carbonate, magnesium hydroxide, silica, potassium titanate fibers, rockwool, or any combination thereof; alternatively, conventional glass fibers; alternatively, glass beads; alternatively, asbestos; alternatively, wollastonite; alternatively, hydrotalcite; alternatively, fiberglass; alternatively, silica; alternatively, potassium titanate fibers; or alternatively, rockwool. Exemplary inorganic fillers can include, but are not limited to, aluminum flakes, zinc flakes, fibers of metals such as brass, aluminum, zinc, or any combination thereof; alternatively, aluminum flakes; alternatively, zinc flakes; or alternatively, fibers of metals such as brass, aluminum, and zinc. Exemplary organic fillers can include, but are not limited to, carbon fibers, carbon black, graphene, graphite, a fullerene, a buckyball, a carbon nanofiber, a carbon nanotube, or any combination thereof; alternatively, carbon fibers; alternatively, carbon black; alternatively, graphene; alternatively, graphite; alternatively, a fullerene; alternatively, a buckyball; alternatively, a carbon nanofiber; or alternatively, a carbon nanotube. Fibers such as conventional glass fibers, milled fibers, carbon fibers and potassium titanate fibers, and inorganic fillers such as mica, talc, and clay can be incorporated into the composition, which can provide molded articles to provide a composition which can have improved properties.

In an embodiment, pigments which can be utilized include, but are not limited to, titanium dioxide, zinc sulfide, or zinc oxide, and mixtures thereof.

In an embodiment, UV absorbers which can be utilized include, but are not limited to, oxalic acid diamide compounds or sterically hindered amine compounds, and mixtures thereof.

In an embodiment, lubricants which can be utilized include, but are not limited to, polyalphaolefins, polyethylene waxes, polyethylene, high density polyethylene (HDPE), polypropylene waxes, and paraffins, and mixtures thereof.

In an embodiment, the fire retardant can be a phosphorus based fire retardant, a halogen based fire retardant, a boron based fire retardant, an antimony based fire retardant, an amide based fire retardant, or any combination thereof. In an embodiment, phosphorus based fire retardants which can be utilized include, but are not limited to, triphenyl phosphate, tricresyl phosphate, a phosphate obtained from a mixture of isopropylphenol and phenol and phosphorus oxychloride, or phosphate esters obtained from difunctional phenols (e.g., benzohydroquinone or bisphenol A), an alcohol, or a phenol and phosphorus oxychloride; alternatively, triphenyl phosphate; alternatively, tricresyl phosphate; alternatively, a phosphate obtained from a mixture of isopropylphenol and phenol and phosphorus oxychloride; or alternatively, phosphate esters obtained from difunctional phenols (e.g., benzohydroquinone or bisphenol A), an alcohol, or a phenol and phosphorus oxychloride. In an embodiment, halogen based fire retardants which can be utilized include, but are not limited to, brominated compounds. In some embodiments, the halogen based fire retardants which can be utilized include, but are not limited to, decabromobiphenyl, pentabromotoluene, decabromobiphenyl ether, hexabromobenzene, or brominated polystyrene. In an embodiment, stabilizers which can be utilized include, but are not limited to, sterically hindered phenols and phosphite compounds.

In an aspect, the poly(arylene sulfide) polymer described herein can further be processed, thereby forming processed poly(arylene sulfide) (e.g., processed PPS). In an embodiment, the poly(arylene sulfide) can be processed by melt processing. In an embodiment, melt processing can generally be any process step(s) which can render the poly(arylene sulfide) in a soft or “moldable state.” In an embodiment, the melt processing can be a step wherein at least part of the polymer composition or mixture subjected to the process is in molten form. In some embodiments, the melt processing can be performed by melting at least part of the polymer composition or mixture. In some embodiments, the melt processing step can be performed with externally applied heat. In other embodiments, the melt processing step itself can generate the heat necessary to melt (or partially melt) the mixture, polymer, or polymer composition. In an embodiment, the melt processing step can be an extrusion process, a melt kneading process, or a molding process. In some embodiments, the melt processing step of any method described herein can be an extrusion process; alternatively, a melt kneading process; or alternatively, a molding process. It should be noted that when any process described herein employs more than one melt processing step, that each melt process step is independent of each other and thus each melt processing step can use the same or different melt processing method. Other melt processing methods are known to those having ordinary skill in the art and can be utilized as the melt processing step.

The poly(arylene sulfide) polymer can be formed or molded into a variety of components or products for a diverse range of applications and industries. For example, the poly(arylene sulfide) can be heated and molded into desired shapes and composites in a variety of processes, equipment, and operations. For example, the poly(arylene sulfide) can be subjected to heat, compounding, injection molding, blow molding, precision molding, film-blowing, extrusion, and so forth. Additionally, additives, such as those mentioned herein, can be blended or compounded within the poly(arylene sulfide). The output of such techniques can include, for example, polymer intermediates or composites including the poly(arylene sulfide), such as for example poly(arylene sulfide) polymer pellets, manufactured product components or pieces formed from the poly(arylene sulfide), and so on.

The poly(arylene sulfide) polymer (e.g., poly(arylene sulfide) polymer pellets, poly(arylene sulfide) polymer powder, etc.) can be further used for making a reinforced poly(arylene sulfide) polymer composition, as will be described in detail herein.

In an embodiment, the reinforced poly(arylene sulfide) polymer composition comprises a poly(arylene sulfide) polymer of the type disclosed herein, a hydroxyl-functionalized reinforcing material, and an ureido silane coupling agent. For example, the poly(arylene sulfide) polymer used in a reinforced poly(arylene sulfide) polymer composition can be a raw poly(arylene sulfide) polymer, a treated poly(arylene sulfide) polymer (e.g., acid treated poly(arylene sulfide) polymer, a metal cation treated poly(arylene sulfide) polymer, an acid and/or metal cation treated poly(arylene sulfide) polymer), a dried poly(arylene sulfide) polymer, a cured poly(arylene sulfide) polymer, a processed poly(arylene sulfide) polymer, or combinations thereof; alternatively, a raw poly(arylene sulfide) polymer; alternatively, a treated poly(arylene sulfide) polymer; alternatively, a dried poly(arylene sulfide) polymer; alternatively, a cured poly(arylene sulfide) polymer; or alternatively, a processed poly(arylene sulfide) polymer.

In an embodiment, the hydroxyl-functionalized reinforcing material comprises a reinforcing material comprising hydroxyl functional groups on at least a portion of an outer surface of the reinforcing material. Generally, a reinforcing material is a substance or material added to a particular composition (e.g., polymer composition, poly(arylene sulfide) polymer composition, PPS composition, etc.) in order to improve or enhance the physical and/or mechanical properties of such composition, e.g., the stability (e.g., hydrolytic stability) of the composition, the tensile strength of the composition, etc. Without wishing to be limited by theory, the presence of hydroxyl functional groups on at least a portion of the outer surface of the reinforcing material can facilitate a binding reaction between the ureido silane coupling agent and the hydroxyl-functionalized reinforcing material, as will be described later herein.

In an embodiment, the hydroxyl-functionalized reinforcing material can be a fiber, e.g., a hydroxyl-functionalized reinforcing material fiber. The hydroxyl-functionalized reinforcing material fiber can be characterized by a fiber length, a fiber diameter and a fiber aspect ratio. The hydroxyl-functionalized reinforcing material fiber can be a straight fiber, a coiled fiber, a twisted fiber, a spiral fiber, a crimped fiber, a crinkled fiber, a crumpled fiber, a curly fiber, a wavy fiber, a fiber with kinks, and the like, or combinations thereof. As will be apparent to one of skill in the art, with the help of this disclosure, the hydroxyl-functionalized reinforcing material (e.g., hydroxyl-functionalized reinforcing material fiber) can perform more than one function as part of the reinforced poly(arylene sulfide) polymer composition (e.g., a hydroxyl-functionalized reinforcing material fiber, such as for example a glass fiber, can be a hydroxyl-functionalized reinforcing material as well as a mineral filler).

In an embodiment, the hydroxyl-functionalized reinforcing material fibers suitable for use in the present disclosure can have a fiber length of from about 0.005 mm to about 15.0 mm, alternatively, from about 0.01 mm to about 5.0 mm, alternatively, from about 0.01 mm to about 3.0 mm, alternatively, from about 0.01 mm to about 1.0 mm, alternatively, from about 0.1 mm to about 0.9 mm, or alternatively, from about 0.25 mm to about 0.75 mm. In an embodiment, the hydroxyl-functionalized reinforcing material fibers suitable for use in the present disclosure can have a fiber length of from about 0.01 mm to about 1.0 mm. In an embodiment, selection of a fiber length of the hydroxyl-functionalized reinforcing material fibers within ranges disclosed herein can aid in the incorporation of the hydroxyl-functionalized reinforcing material fibers into the reinforced poly(arylene sulfide) polymer composition.

In an embodiment, the hydroxyl-functionalized reinforcing material fibers suitable for use in the present disclosure can have a fiber diameter of from about 5 microns to about 15 microns, alternatively, from about 6 microns to about 13 microns, or alternatively, from about 7 microns to about 11 microns.

In an embodiment, the hydroxyl-functionalized reinforcing material fibers suitable for use in the present disclosure can have a fiber aspect ratio of from about 1 to about 1,000, alternatively, from about 1 to about 500, alternatively from about 1 to about 200, alternatively, from about 5 to about 150, or alternatively, from about 10 to about 100. In an embodiment, the hydroxyl-functionalized reinforcing material fibers suitable for use in the present disclosure can have a fiber aspect ratio of from about 1 to about 200. Generally, the fiber aspect ratio can be calculated by dividing the fiber length by the fiber diameter. In an embodiment, selection of a fiber aspect ratio of the hydroxyl-functionalized reinforcing material fibers within ranges disclosed herein can aid in reinforcing the reinforced poly(arylene sulfide) polymer composition.

In an embodiment, the hydroxyl-functionalized reinforcing material fibers suitable for use in the present disclosure can be further characterized by a tensile strength of from about 2,000 MPa to about 5,000 MPa, alternatively, from about 2,500 MPa to about 4,500 MPa, or alternatively, from about 3,000 MPa to about 4,000 MPa. Generally, the tensile strength (also known as breaking strength) of a material (e.g., a fiber) can be defined as the maximum longitudinal stress a material (e.g., a fiber) can withstand before tearing (e.g., before the material or fiber breaks), and is commonly expressed in MPa (i.e., 1 MPa=1×10⁶ Pa).

In an embodiment, the hydroxyl-functionalized reinforcing materials suitable for use in the present disclosure can be further characterized by a thermal stability of up to about 1,200° C., alternatively, up to about 1,150° C., or alternatively, up to about 1,100° C. Generally, the thermal stability of a material or compound can be defined as the temperature where the material or compound loses its physical, mechanical and/or chemical properties, such as for example the material or compound melts, softens, decomposes, etc.

In an embodiment, the hydroxyl-functionalized reinforcing material comprises glass fibers.

In an embodiment, a reinforced poly(arylene sulfide) polymer composition comprises a hydroxyl-functionalized reinforcing material of the type disclosed herein in an amount of from about 30 wt. % to about 45 wt. %, alternatively, from about 35 wt. % to about 45 wt. %, or alternatively, from about 39 wt. % to about 41 wt. %, based on the total weight of the reinforced poly(arylene sulfide) polymer composition.

In an embodiment, the ureido silane coupling agent can be a multifunctional compound. Generally, a multifunctional compound comprises two or more functional groups that can react and form covalent bonds with other molecules. In an embodiment, the ureido silane coupling agent is a bifunctional compound comprising two functional groups that can react and form covalent bonds with other molecules. In an embodiment, an ureido silane coupling agent suitable for use in the present disclosure comprises both an ureido functional group that can covalently bond to a poly(arylene sulfide) polymer and a silane functional group that can covalently bond to a hydroxyl-functionalized reinforcing material, as will be described in more detail later herein.

In an embodiment, the ureido silane coupling agent comprises a compound represented by Formula IV and/or a compound represented by Formula V.

H₂N—CO—NH—CₘH₂ₘ—Si(OR⁵)₃ Formula IV

H₂N—CO—NH—CₓH_{y}—Si(OR⁵)₃ Formula V

In an embodiment, m can be an integer with a value of equal to or greater than 1, alternatively, equal to or greater than 2, or alternatively, equal to or greater than 3. In an embodiment, m is 3. In an embodiment, x and y can both be integers, wherein x can have a value of equal to or greater than 1, alternatively, equal to or greater than 2, or alternatively, equal to or greater than 3; and wherein y can have a value of equal to or greater than 2, alternatively, equal to or greater than 4, or alternatively, equal to or greater than 6. In an embodiment, x is 3 and y is 6. In an embodiment, —CₘH₂ₘ— of Formula IV and/or —CₓH_{y}— of Formula V can be —CH₂—CH₂—CH₂—. In an embodiment, R⁵ can be any hydrocarbon functionality. In an embodiment, R⁵ comprises an alkyl group. In an embodiment, R⁵ can be methyl, ethyl, propyl or butyl; alternatively, methyl; alternatively, ethyl; alternatively, propyl; or alternatively, butyl. In some embodiments, R⁵ can be methyl. In other embodiments, R⁵ can be ethyl.

In an embodiment, the compound represented by Formula IV and/or the compound represented by Formula V comprise a γ-ureidopropyltrialkoxy silane represented by Formula VI.

H₂N—CO—NH—CH₂—CH₂—CH₂—Si(OR⁵)₃ Formula VI

In an embodiment, the γ-ureidopropyltrialkoxy silane represented by Formula VI comprises a γ-ureidopropyltrimethoxy silane represented by Formula VII and/or a γ-ureidopropyltriethoxy silane represented by Formula VIII.

H₂N—CO—NH—CH₂—CH₂—CH₂—Si(OCH₃)₃ Formula VII

H₂N—CO—NH—CH₂—CH₂—CH₂—Si(OC₂H₅)₃ Formula VIII

In an embodiment, the ureido silane coupling agent comprises an ureido functional group (e.g., H₂N—CO—NH—) that can bond (e.g., covalently bond) to a poly(arylene sulfide) polymer. Without wishing to be limited by theory, a poly(arylene sulfide) (e.g., PPS) polymer can have —ZH groups present, wherein Z can be O and/or S, such as for example hydroxyl groups (e.g., —OH) and/or sulfhydryl groups (e.g., —SH), and such —ZH groups can react with an ureido functional group of the ureido silane coupling agent to form a covalent bond between the polymer and the silane, according to the following equations:

PAS-ZH+H₂N—CO—NH—CₘH₂ₘ—Si(OR⁵)₃→PAS-Z—CO—NH—CₘH₂ₘ—Si(OR⁵)₃+NH₃ and/or

PAS-ZH+H₂N—CO—NH—CₓH_{y}—Si(OR⁵)₃→PAS-Z—CO—NH—CₓH_{y}—Si(OR⁵)₃+NH₃,

wherein PAS represents a poly(arylene sulfide) polymer, and wherein m, x, y, and R⁵ have been described previously herein for the ureido silane coupling agents having Formula IV and/or Formula V.

In an embodiment, the ureido silane coupling agent comprises a silane functional group (e.g., —Si(OR⁵)₃) that can bond (e.g., covalently bond) to a hydroxyl-functionalized reinforcing material. Without wishing to be limited by theory, the hydroxyl groups (e.g., —OH) of the hydroxyl-functionalized reinforcing material can react with a silane functional group of the ureido silane coupling agent to form a covalent bond between the reinforcing material and the silane, according to the following equations:

RM-OH+(R⁵O)₃Si—CₘH₂ₘ—NH—CO—NH₂→RM-O—Si(OR⁵)₂—CₘH₂ₘ—NH—CO—NH₂+R⁵OH

and/or

RM-OH+(R⁵O)₃Si—CₓH_{y}—NH—CO—NH₂→RM-O—Si(OR⁵)₂—CₓH_{y}—NH—CO—NH₂+R⁵OH,

wherein RM represents a reinforcing material, wherein RM-OH represents a hydroxyl-functionalized reinforcing material, and wherein m, x, y, and R⁵ have been described previously herein for the ureido silane coupling agents having Formula IV and/or Formula V.

Further, without wishing to be limited by theory, an ureido silane coupling agent, when present in a reinforced poly(arylene sulfide) polymer composition of the type disclosed herein, can provide a means for covalent bonding between the poly(arylene sulfide) polymer and the hydroxyl-functionalized reinforcing material (e.g., tethering or linking the poly(arylene sulfide) polymer and the hydroxyl-functionalized reinforcing material) by forming a tethered compound represented by Formula IX and/or a tethered compound represented by Formula X:

RM—O—Si(OR⁵)₂—CₘH₂ₘ—NH—CO—Z-PAS Formula IX

RM-O—Si(OR⁵)₂—CₓH_{y}—NH—CO—Z-PAS Formula X

wherein RM represents a reinforcing material, wherein PAS represents a poly(arylene sulfide) polymer, and wherein m, x, y, and R⁵ have been described previously herein for the ureido silane coupling agents having Formula IV and/or Formula V.

Nonlimiting examples of commercially available ureido silane coupling agents suitable for use in the present disclosure include SILQUEST® A-1524 silane, SILQUEST® Y-11542 silane, SILQUEST® A-1160 silane, SISIB PC2520 silane, or combinations thereof. SILQUEST® A-1524 silane and SILQUEST® Y-11542 silane are γ-ureidopropyltrimethoxy silanes, SILQUEST® A-1160 silane is a mixture of γ-ureidopropyltrialkoxy silanes, all which are available from Momentive Performance Materials. SISIB PC2520 silane is a γ-ureidopropyltriethoxy silane available from Power Chemical Corporation.

In an embodiment, a reinforced poly(arylene sulfide) polymer composition comprises an ureido silane coupling agent of the type disclosed herein in an amount of from about 0.1 wt. % to about 1 wt. %, alternatively, from about 0.25 wt. % to about 0.75 wt. %, or alternatively, from about 0.4 wt. % to about 0.6 wt. %, based on the total weight of the reinforced poly(arylene sulfide) polymer composition.

In an embodiment, the reinforced poly(arylene sulfide) polymer composition can further comprise optional additives, wherein an additive may be added in an amount effective to perform an intended function. In an embodiment, the poly(arylene sulfide) polymer can comprise the balance of the reinforced poly(arylene sulfide) polymer composition after considering the amount of the other components used.

In an embodiment, the reinforced poly(arylene sulfide) polymer composition can be characterized by a tensile strength of from about 50 MPa to about 300 MPa, alternatively, from about 100 MPa to about 250 MPa, or alternatively, from about 150 MPa to about 200 MPa. The tensile strength of a reinforced poly(arylene sulfide) polymer composition can be determined in accordance with ASTM D638-03 and/or ISO 527-2 (1993).

In an embodiment, the reinforced poly(arylene sulfide) polymer composition can be characterized by a tensile modulus of from about 13,000 MPa to about 17,000 MPa, alternatively, from about 14,000 MPa to about 16,000 MPa, or alternatively, from about 14,500 MPa to about 15,500 MPa. The tensile modulus, which is also known as Young's modulus or the elastic modulus, can be expressed in MPa and is a measure of the stiffness of a material, and is generally defined as the ratio of the stress along an axis over the strain along that axis in the range of stress in which Hooke's law applies. The tensile modulus of a reinforced poly(arylene sulfide) polymer composition can be determined in accordance with ASTM D638-03 and/or ISO 527-2 (1993).

In an embodiment, the reinforced poly(arylene sulfide) polymer composition can be characterized by a tensile strain of from about 0.5% to about 2.5%, alternatively, from about 0.75% to about 2%, or alternatively, from about from about 1% to about 1.75%. The tensile strain or break strain of a material is generally defined as the % ratio of the elongation of a material (e.g., how much a length of the material increased by) to the original length of the material (e.g., the length of the material prior to applying a force to the material). The tensile strain of a reinforced poly(arylene sulfide) polymer composition can be determined in accordance with ASTM D638-03 and/or ISO 527-2 (1993).

In an embodiment, the reinforced poly(arylene sulfide) polymer composition can be characterized by a water absorption of about 0.2 wt. %, alternatively, about 0.15 wt. %, or alternatively, about 0.1 wt. %, based on the weight of the reinforced poly(arylene sulfide) polymer composition. In an embodiment, the water absorption of a reinforced poly(arylene sulfide) polymer composition can be determined in accordance with a comparison of the weight of a tensile test specimen (e.g., a test specimen or test sample, such as for example a reinforced poly(arylene sulfide) polymer composition sample, subjected to a tensile strength test, a tensile modulus test, a tensile strain test, etc.) before aging (e.g., hot water aging) to the weight of the same tensile test specimen after a specified aging procedure (e.g., hot water aging procedure, as disclosed herein). The water absorption of a material represents the amount of water absorbed by a material (e.g., a polymer, such as for example a poly(arylene sulfide) polymer, a reinforced poly(arylene sulfide) polymer composition, etc.) under specified conditions (e.g., hot water aging conditions), based on the weight of such material (e.g., a polymer, such as for example a poly(arylene sulfide) polymer, a reinforced poly(arylene sulfide) polymer composition, etc.).

In an embodiment, the reinforced poly(arylene sulfide) polymer composition can be characterized by improved physical and/or mechanical properties (e.g., tensile strength, tensile modulus, etc.), as compared to an otherwise similar reinforced polymer composition lacking an ureido silane coupling agent. For example, if a reinforced poly(arylene sulfide) polymer composition is characterized by a tensile strength of 190 MPa, and an otherwise similar reinforced polymer composition lacking an ureido silane coupling agent is characterized by a tensile strength of 155 MPa, then the reinforced poly(arylene sulfide) polymer composition is characterized by a tensile strength that is increased when compared to the otherwise similar reinforced polymer composition lacking an ureido silane coupling agent by 35 MPa. For example, if a reinforced poly(arylene sulfide) polymer composition is characterized by a tensile modulus of 15,000 MPa, and an otherwise similar reinforced polymer composition lacking an ureido silane coupling agent is characterized by a tensile modulus of 14,500 MPa, then the reinforced poly(arylene sulfide) polymer composition is characterized by a tensile modulus that is increased when compared to the otherwise similar reinforced polymer composition lacking an ureido silane coupling agent by 500 MPa.

In an embodiment, the reinforced poly(arylene sulfide) polymer composition can be characterized by a tensile strength that is increased when compared to an otherwise similar reinforced polymer composition lacking an ureido silane coupling agent by from about 10 MPa to about 50 MPa, alternatively, from about 15 MPa to about 40 MPa, or alternatively, from about

MPa to about 30 MPa.

In an embodiment, the reinforced poly(arylene sulfide) polymer composition can be characterized by a tensile strength that is increased when compared to an otherwise similar reinforced polymer composition lacking an ureido silane coupling agent by from about 100 MPa to about 1,000 MPa, alternatively, from about 200 MPa to about 750 MPa, or alternatively, from about 300 MPa to about 600 MPa.

In an embodiment, the reinforced poly(arylene sulfide) polymer composition can be characterized by improved physical and/or mechanical properties, such as for example improved stability (e.g., hydrolytic stability), when exposed for a predetermined time period to water (e.g., hot water, hot water vapors) at elevated temperatures, as compared to an otherwise similar reinforced polymer composition lacking an ureido silane coupling agent. For purposes of the disclosure herein, the stability of a polymer composition (e.g., reinforced polymer composition, reinforced poly(arylene sulfide) polymer composition) can be defined as the ability of such composition to retain its physical and/or mechanical properties over time when exposed to certain conditions (e.g., hot water, hot water vapors), and the stability (e.g., hydrolytic stability) can be expressed or quantified as % property retention (e.g., % tensile strength retention, % tensile modulus retention, % tensile strain retention, etc.), wherein the % property retention can be calculated based on the value of the property measured before exposure (e.g., initial property value) of the polymer composition to the condition(s) to be tested (e.g., hot water, hot water vapors), according to equation 1:

$$\% property retention = \frac{final property value}{initial property value} \times 100 \qquad ( 1 )$$

wherein the final property value is the value of the property measured at the end of the exposure of the polymer composition to the condition(s) to be tested (e.g., hot water, hot water vapors). For purposes of the disclosure herein, when the condition to be tested is exposure to water (e.g., hot water, hot water vapors), the stability of the composition can also be referred to as “hydrolytic stability,” which refers to the ability of the composition to withstand hydrolysis. Without wishing to be limited by theory, exposure to water (e.g., hot water, hot water vapors) over time can lead to hydrolysis of a bond (e.g., covalent bond) between the poly(arylene sulfide) polymer and the ureido silane coupling agent, and/or a bond (e.g., covalent bond) between the hydroxyl-functionalized reinforcing material and the ureido silane coupling agent. The term “otherwise similar” as used herein is understood to include, but not limited to, embodiments where an “otherwise similar” polymer, polymer composition, article or the like refers to the same or identical (including but not limited to the same or identical as determined within the tolerances or variances of known testing procedures or protocols) polymer, polymer composition, article or the like with the exception of the specific feature that is identified as different (e.g., the presence or absence of an ureido silane coupling agent). The term “otherwise similar” is also understood to include comparisons of novel embodiments to control embodiments, where variables or parameters related to the polymer, polymer composition, article or the like are held constant within accepted scientific practice as understood by those skilled in the art with the exception of one or more designated variables or parameters of interest (e.g., the presence or absence of an ureido silane coupling agent).

In an embodiment, the testing conditions (e.g., procedures, protocols) for determining a % property retention of a reinforced poly(arylene sulfide) polymer composition comprise aging the reinforced poly(arylene sulfide) polymer composition in hot water at a temperature of equal to or greater than about 140° C., alternatively, equal to or greater than about 120° C., or alternatively, equal to or greater than about 100° C., over a time period of about 2,000 hours, alternatively, about 1,000 hours, or alternatively, about 500 hours. For purposes of the disclosure herein, testing a polymer composition (e.g., a reinforced poly(arylene sulfide) polymer composition) for % property retention will be understood to include without limitation the following steps: (i) forming the polymer composition (e.g., a reinforced poly(arylene sulfide) polymer composition) into a test article, such as for example a molded test article or an extruded test article, as indicated by a testing procedure (e.g., standard testing procedure) for a particular property to be tested (e.g., ASTM D638-03 and/or ISO 527-2 (1993) for tensile strength, tensile modulus, tensile strain, etc.); (ii) subjecting the test article to a property testing as indicated by a testing procedure (e.g., standard testing procedure) for the particular property to be tested (e.g., ASTM D638-03 and/or ISO 527-2 (1993) for tensile strength, tensile modulus, tensile strain, etc.), and recording an initial property value; (iii) submerging or immersing a similar or identical test article in water, wherein the water is heated and maintained at a testing temperature (e.g., about 140° C.) for the duration of the hot water aging (e.g., about 2,000 hours), to yield an aged test article; and (iv) recovering the aged test article and subjecting the aged test article to a property testing as indicated by a testing procedure (e.g., standard testing procedure) for the particular property to be tested (e.g., ASTM D638-03 and/or ISO 527-2 (1993) for tensile strength, tensile modulus, tensile strain, etc.), and recording a final property value; and (v) calculating the % property retention according to Equation 1.

In an embodiment, the reinforced poly(arylene sulfide) polymer composition can be characterized by equal to or greater than about 70% tensile strength retention, alternatively, equal to or greater than about 75% tensile strength retention, alternatively, equal to or greater than about 80% tensile strength retention, alternatively, equal to or greater than about 85% tensile strength retention, alternatively, equal to or greater than about 90% tensile strength retention, alternatively, equal to or greater than about 95% tensile strength retention, alternatively, equal to or greater than about 96% tensile strength retention, alternatively, equal to or greater than about 97% tensile strength retention, alternatively, equal to or greater than about 98% tensile strength retention, alternatively, equal to or greater than about 99% tensile strength retention, or alternatively, about 100% tensile strength retention, when the reinforced poly(arylene sulfide) polymer composition is exposed to water (e.g., hot water, hot water vapors) at a temperature of equal to or greater than about 140° C., alternatively, equal to or greater than about 120° C., or alternatively, equal to or greater than about 100° C., over a time period of about 2,000 hours, alternatively, about 1,000 hours, or alternatively, about 500 hours.

In an embodiment, the reinforced poly(arylene sulfide) polymer composition can be characterized by equal to or greater than about 85% tensile modulus retention, alternatively, equal to or greater than about 90% tensile modulus retention, alternatively, equal to or greater than about 95% tensile modulus retention, alternatively, equal to or greater than about 96% tensile modulus retention, alternatively, equal to or greater than about 97% tensile modulus retention, alternatively, equal to or greater than about 98% tensile modulus retention, alternatively, equal to or greater than about 99% tensile modulus retention, or alternatively, about 100% tensile modulus retention, when the reinforced poly(arylene sulfide) polymer composition is exposed to water (e.g., hot water, hot water vapors) at a temperature of equal to or greater than about 140° C., alternatively, equal to or greater than about 120° C., or alternatively, equal to or greater than about 100° C., over a time period of about 2,000 hours, alternatively, about 1,000 hours, or alternatively, about 500 hours.

In an embodiment, the reinforced poly(arylene sulfide) polymer composition can be characterized by equal to or greater than about 70% tensile strain retention, alternatively, equal to or greater than about 75% tensile strain retention, alternatively, equal to or greater than about 80% tensile strain retention, alternatively, equal to or greater than about 85% tensile strain retention, alternatively, equal to or greater than about 90% tensile strain retention, alternatively, equal to or greater than about 95% tensile strain retention, alternatively, equal to or greater than about 96% tensile strain retention, alternatively, equal to or greater than about 97% tensile strain retention, alternatively, equal to or greater than about 98% tensile strain retention, alternatively, equal to or greater than about 99% tensile strain retention, or alternatively, about 100% tensile strain retention, when the reinforced poly(arylene sulfide) polymer composition is exposed to water (e.g., hot water, hot water vapors) at a temperature of equal to or greater than about 140° C., alternatively, equal to or greater than about 120° C., or alternatively, equal to or greater than about 100° C., over a time period of about 2,000 hours, alternatively, about 1,000 hours, or alternatively, about 500 hours.

In an embodiment, the reinforced poly(arylene sulfide) polymer composition can be characterized by improved % property retention (e.g., % tensile strength retention, % tensile modulus retention, % tensile strain retention, etc.), as compared to an otherwise similar reinforced polymer composition lacking an ureido silane coupling agent, wherein the polymer composition samples are exposed to the same conditions for the same period of time, such as for example the polymer composition samples are aged in hot water at about 140° C. over about 2000 hours. For example, if a reinforced poly(arylene sulfide) polymer composition is characterized by a 99% property retention, and an otherwise similar reinforced polymer composition lacking an ureido silane coupling agent is characterized by a 82% property retention (for the same property), then the reinforced poly(arylene sulfide) polymer composition is characterized by a % property retention that is increased when compared to the otherwise similar reinforced polymer composition lacking an ureido silane coupling agent by 17%.

In an embodiment, the reinforced poly(arylene sulfide) polymer composition can be characterized by a % tensile strength retention that is increased when compared to an otherwise similar reinforced polymer composition lacking an ureido silane coupling agent by equal to or greater than about 15%, alternatively, equal to or greater than about 20%, or alternatively, equal to or greater than about 25%, wherein the tensile strength is determined in accordance with ASTM D638-03 and/or ISO 527-2 (1993) and the polymer composition samples are aged in hot water at about 140° C. over about 2000 hours.

In an embodiment, the reinforced poly(arylene sulfide) polymer composition can be characterized by a % tensile modulus retention that is increased when compared to an otherwise similar reinforced polymer composition lacking an ureido silane coupling agent by equal to or greater than about 5%, alternatively, equal to or greater than about 10%, or alternatively, equal to or greater than about 15%, wherein the tensile modulus is determined in accordance with ASTM D638-03 and/or ISO 527-2 (1993) and the polymer composition samples are aged in hot water at about 140° C. over about 2000 hours.

In an embodiment, the reinforced poly(arylene sulfide) polymer composition can be characterized by a % tensile strain retention that is increased when compared to an otherwise similar reinforced polymer composition lacking an ureido silane coupling agent by equal to or greater than about 10%, alternatively, equal to or greater than about 15%, alternatively, equal to or greater than about 20%, or alternatively, equal to or greater than about 25%, wherein the tensile strain is determined in accordance with ASTM D638-03 and/or ISO 527-2 (1993) and the polymer composition samples are aged in hot water at about 140° C. over about 2000 hours.

In an embodiment, the reinforced poly(arylene sulfide) polymer composition comprises a poly(arylene sulfide) polymer, a hydroxyl-functionalized reinforcing material, an ureido silane coupling agent, and an additive (e.g., a polyalphaolefin). In an embodiment, the reinforced poly(arylene sulfide) polymer composition comprises PPS, glass fiber, γ-ureidopropyltrimethoxy silane, and high density polyethylene. For example, the reinforced poly(arylene sulfide) polymer composition can comprise 59.25 wt. % PPS, 40 wt. % glass fiber, 0.5 wt. % γ-ureidopropyltrimethoxy silane, and 0.25 wt. % high density polyethylene. In such embodiment, the reinforced poly(arylene sulfide) polymer composition can be characterized by a tensile strength of about 190 MPa, a tensile modulus of about 15,000 MPa, and a tensile strain of about 1.75%.

In an alternative embodiment, the reinforced poly(arylene sulfide) polymer composition comprises a poly(arylene sulfide) polymer, a hydroxyl-functionalized reinforcing material, an ureido silane coupling agent, and an additive (e.g., a polyalphaolefin). In an embodiment, the reinforced poly(arylene sulfide) polymer composition comprises PPS, glass fiber, γ-ureidopropyltriethoxy silane, and high density polyethylene. For example, the reinforced poly(arylene sulfide) polymer composition can comprise 59.25 wt. % PPS, 40 wt. % glass fiber, 0.5 wt. % γ-ureidopropyltriethoxy silane, and 0.25 wt. % high density polyethylene. In such embodiment, the reinforced poly(arylene sulfide) polymer composition can be characterized by a tensile strength of about 190 MPa, a tensile modulus of about 15,000 MPa, and a tensile strain of about 1.75%.

In another embodiment, the reinforced poly(arylene sulfide) polymer composition comprises a poly(arylene sulfide) polymer, a hydroxyl-functionalized reinforcing material, an ureido silane coupling agent, and additives (e.g., mineral fillers, polyalphaolefins, etc.). In an embodiment, the reinforced poly(arylene sulfide) polymer composition comprises PPS, glass fiber, γ-ureidopropyltrimethoxy silane, hydrotalcite, and high density polyethylene. For example, the reinforced poly(arylene sulfide) polymer composition can comprise 57.35 wt. % PPS, 41 wt. % glass fiber, 0.5 wt. % γ-ureidopropyltrimethoxy silane, 1 wt. % hydrotalcite, and 0.15 wt. % high density polyethylene. In such embodiment, the reinforced poly(arylene sulfide) polymer composition can be characterized by a tensile strength of about 180 MPa, a tensile modulus of about 16,000 MPa, and a tensile strain of about 1.5%.

In yet another embodiment, the reinforced poly(arylene sulfide) polymer composition comprises a poly(arylene sulfide) polymer, a hydroxyl-functionalized reinforcing material, an ureido silane coupling agent, and additives (e.g., mineral fillers, polyalphaolefins, etc.). In an embodiment, the reinforced poly(arylene sulfide) polymer composition comprises PPS, glass fiber, γ-ureidopropyltriethoxy silane, hydrotalcite, and high density polyethylene. For example, the reinforced poly(arylene sulfide) polymer composition can comprise 57.35 wt. % PPS, 41 wt. % glass fiber, 0.5 wt. % γ-ureidopropyltriethoxy silane, 1 wt. % hydrotalcite, and 0.15 wt. % high density polyethylene. In such embodiment, the reinforced poly(arylene sulfide) polymer composition can be characterized by a tensile strength of about 180 MPa, a tensile modulus of about 16,000 MPa, and a tensile strain of about 1.5%.

In an embodiment, the reinforced poly(arylene sulfide) polymer composition comprising a poly(arylene sulfide) polymer, a hydroxyl-functionalized reinforcing material, an ureido silane coupling agent, and optional additives can be prepared using any suitable methodology.

In an embodiment, the reinforced poly(arylene sulfide) polymer composition of the type disclosed herein can be prepared by an extrusion process, such as for example extrusion compounding. Generally, extrusion compounding is a process for mixing one or more polymers with one or more additives to yield desired polymer compositions, e.g., a process for compound extruding one or more polymers with one or more additives to yield desired polymer compositions. The extrusion compounding process can be carried out with an extruder (e.g., a compounding extruder), such as for example a single screw extruder or with a twin screw extruder.

In some embodiments, the poly(arylene sulfide) polymer (e.g., a dry polymer powder) and the ureido silane coupling agent can be combined and mixed, such as for example combined and mixed in a blender, prior to adding the poly(arylene sulfide) polymer to the extruder (e.g., a compounding extruder), to form a polymer mixture. In such embodiments, the polymer mixture and the hydroxyl-functionalized reinforcing material can be added to the extruder at the same time.

In other embodiments, the hydroxyl-functionalized reinforcing material and the ureido silane coupling agent can be combined and mixed, such as for example combined and mixed in a mixer, prior to adding the hydroxyl-functionalized reinforcing material to the extruder (e.g., a compounding extruder), to form a reinforcing material mixture. In such embodiments, the reinforcing material mixture and the poly(arylene sulfide) polymer can be added to the extruder at the same time.

In yet other embodiments, the poly(arylene sulfide) polymer (e.g., a dry polymer powder) and the hydroxyl-functionalized reinforcing material can be combined and mixed, such as for example combined and mixed in a mixer, prior to adding the poly(arylene sulfide) polymer to the extruder (e.g., a compounding extruder), to form a reinforcing polymer mixture. In such embodiments, the reinforcing polymer mixture and the ureido silane coupling agent can be added to the extruder at the same time.

In still yet other embodiments, the poly(arylene sulfide) polymer, the hydroxyl-functionalized reinforcing material, the ureido silane coupling agent, and optional additives can be added to the extruder at the same time, with no pre-mixing of any of the components/ingredients.

As will be appreciated by one of skill in the art, and with the help of this disclosure, when any of the components of the reinforced poly(arylene sulfide) polymer composition are pre-mixed prior to adding any such components to the extruder, optional additives can be added to any of the pre-mixed components and/or to the extruder.

The extruder melts the polymer at temperatures of from about 250° C. to about 450° C., thereby enabling the uniform mixing of the reinforcing material (e.g., hydroxyl-functionalized reinforcing material) and coupling agent (e.g., ureido silane coupling agent) throughout the polymer composition, and a molten polymer composition can be extruded as an extruded reinforced poly(arylene sulfide) polymer composition. The molten polymer can be extruded into strands, which strands can be passed through a water bath and then sized (e.g., chopped) into pellets (e.g., extruded reinforced poly(arylene sulfide) polymer composition pellets) or any other desired geometry. The pellets can be dried prior to further use.

In an aspect, the reinforced poly(arylene sulfide) polymer compositions described herein can be further processed, thereby forming processed reinforced poly(arylene sulfide) polymer compositions. In an embodiment, the reinforced poly(arylene sulfide) polymer compositions can be processed by melt processing. As will be appreciated by one of skill in the art, and with the help of this disclosure, the melt processing used for processing the poly(arylene sulfide) polymer is the same or similar to the melt processing used for processing the reinforced poly(arylene sulfide) polymer compositions.

The reinforced poly(arylene sulfide) polymer compositions can be formed or molded into a variety of components or products for a diverse range of applications and industries. For example, the reinforced poly(arylene sulfide) polymer composition can be heated and molded into desired shapes and composites in a variety of processes, equipment, and operations. For example, the reinforced poly(arylene sulfide) polymer composition can be subjected to heat, compounding, injection molding, blow molding, precision molding, film-blowing, extrusion, and so forth. Additionally, additives, such as those mentioned herein, can be blended or compounded within the reinforced poly(arylene sulfide) polymer compositions. The output of such techniques can include, for example, polymer intermediates or composites including the reinforced poly(arylene sulfide) polymer compositions, and manufactured product components, pieces or articles formed from the reinforced poly(arylene sulfide) polymer compositions, such as for example an extruded article, a molded article, and so on. These articles (e.g., manufactured articles or components) can be sold or delivered directly to a user. On the other hand, the components can be further processed or assembled in end products, for example, in the industrial, consumer, automotive, aerospace, solar panel, and electrical/electronic industries, which can need polymers that have conductivity, high strength, and high modulus, among other properties. Some examples of end products include without limitation electrical insulation, specialty membranes, gaskets, and packing materials. Some examples of articles (e.g., extruded articles, molded articles) include a component of an automotive coolant system (e.g., automotive engine coolant system), a component of a hot water plumbing assembly, a component of a hot water appliance, etc. Some examples of articles (e.g., extruded articles, molded articles) include pipes, such as for example pipes for automotive coolant systems (e.g., automotive engine coolant systems), pipes for hot water plumbing assemblies, pipes for hot water appliances, etc. On the other hand, the components can be further processed or assembled in end products, for example, in the automotive industry, which can need polymers that have high % property retention, such as, for example, % tensile strength retention, % tensile modulus retention, and % tensile strain retention, among others.

In an embodiment, a hot water conveyance assembly comprises at least one fiber-reinforced, extruded component in contact with said hot water, wherein said fiber-reinforced, extruded component is formed via extrusion (e.g., extrusion compounding) of a reinforced poly(arylene sulfide) polymer composition (e.g., a reinforced poly(phenylene sulfide) polymer composition). In such embodiment, the fiber-reinforced, extruded component comprises a pipe.

In an embodiment, the reinforced poly(arylene sulfide) polymer composition advantageously displays improved physical and/or mechanical properties, such as for example improved stability (e.g., hydrolytic stability), when exposed for a predetermined time period to water (e.g., hot water, hot water vapors) at elevated temperatures, as compared to an otherwise similar reinforced polymer composition lacking an ureido silane coupling agent. For example, the reinforced poly(arylene sulfide) polymer composition advantageously displays a % tensile strength retention, a % tensile modulus retention and/or a % tensile strain retention that is increased when compared to an otherwise similar reinforced polymer composition lacking an ureido silane coupling agent.

In an embodiment, the use of an ureido silane coupling agent in the reinforced poly(arylene sulfide) polymer composition of the type disclosed herein can advantageously improve an interfacial adhesion between the hydroxyl-functionalized reinforcing material (e.g., glass fibers) and the poly(arylene sulfide) (e.g., PPS) polymer, thereby improving the physical and/or mechanical properties of the reinforced poly(arylene sulfide) polymer composition.

In an embodiment, the reinforced poly(arylene sulfide) polymer composition of the type disclosed herein can be advantageously used for manufacturing items or articles that need to retain their properties when exposed to hot water or heated water vapors for an extended time period (e.g., months, years), such as for example a component (e.g., a pipe) of an automotive coolant system, a component (e.g., a pipe) of a hot water plumbing assembly, a component (e.g., a pipe) of a hot water appliance, etc.

For the purpose of any U.S. national stage filing from this application, all publications and patents mentioned in this disclosure are incorporated herein by reference in their entireties, for the purpose of describing and disclosing the constructs and methodologies described in those publications, which might be used in connection with the methods of this disclosure. Any publications and patents discussed herein are provided solely for their disclosure prior to the filing date of the present application. Nothing herein is to be construed as an admission that the inventors are not entitled to antedate such disclosure by virtue of prior invention.

In any application before the United States Patent and Trademark Office, the Abstract of this application is provided for the purpose of satisfying the requirements of 37 C.F.R. §1.72 and the purpose stated in 37 C.F.R. §1.72(b) “to enable the United States Patent and Trademark Office and the public generally to determine quickly from a cursory inspection the nature and gist of the technical disclosure.” Therefore, the Abstract of this application is not intended to be used to construe the scope of the claims or to limit the scope of the subject matter that is disclosed herein. Moreover, any headings that can be employed herein are also not intended to be used to construe the scope of the claims or to limit the scope of the subject matter that is disclosed herein. Any use of the past tense to describe an example otherwise indicated as constructive or prophetic is not intended to reflect that the constructive or prophetic example has actually been carried out.

The present disclosure is further illustrated by the following examples, which are not to be construed in any way as imposing limitations upon the scope thereof. On the contrary, it is to be clearly understood that resort can be had to various other aspects, embodiments, modifications, and equivalents thereof which, after reading the description herein, can be suggest to one of ordinary skill in the art without departing from the spirit of the present invention or the scope of the appended claims.

### EXAMPLES

The following examples are set forth to provide a detailed description of how the methods claimed herein are evaluated, and are not intended to limit the scope of what the inventors regard as their invention.

### Example 1

The properties of reinforced PPS (polyphenylene sulfide) polymer compositions were investigated. More specifically, the tensile strength, the tensile modulus, and the tensile strain for reinforced PPS polymer compositions samples were investigated both for samples with and without an ureido silane coupling agent. The % tensile strength retention, the % tensile modulus retention, and the % tensile strain retention were calculated from the available data as described previously herein.

The reinforced PPS (polyphenylene sulfide) polymer composition samples were prepared by mixing all of the ingredients/components (e.g., PPS, ureido silane coupling agent high density polyethylene, optionally hydrotalcite), except for the hydroxyl-functionalized reinforcing material, in a blender, such as for example a Henschel blender, to yield a first polymer mixture. The first polymer mixture was then combined with glass fibers used as the hydroxyl-functionalized reinforcing material and melt compounded using a twin screw extruder (in the case of Example 1) or a single screw extruder (in the case of Example 2) at temperatures of from about 315° C. to about 375° C. The molten polymer compositions were then extruded into strands and passed through a water bath prior to being chopped into pellets. The resulting pellets were dried at 150° C. for at least two hours, and were then molded into test articles or specimens for tensile testing (e.g., tensile strength testing, tensile modulus testing, tensile strain testing) by injection molding at melt temperatures of 315° C. to 345° C. with mold cavity surface temperatures of 135° C. to 150° C. All tensile testing in the case of Example 1 were conducted in accordance with standard test methods ISO 527-2 (1993). The test articles were subjected to tensile testing to obtain initial property values (0 hours values), and the data are displayed in Table 1. Similar or identical test articles (e.g., molded test specimens) were subjected to hot water aging. Hot water aging of the test articles (e.g., molded test specimens) was conducted by submerging or immersing the test articles (e.g., molded test specimens) in deionized water within a closed stainless steel pressure vessel heated to 140° C., over various time periods (e.g., 500 hours, 1,000 hours, and 2,000 hours), as noted in Table 1, to yield aged test articles (e.g., aged molded test specimens). The aged test articles (e.g., aged molded test specimens) were then recovered and subjected to tensile testing to obtain final property values (e.g., 500 hours, 1,000 hours, and 2,000 hours values), and the data are displayed in Table 1. PPS Lot 1 is comparable to RYTON® QA200N PPS; and PPS Lot 2 is comparable to RYTON® QA320N PPS. Table 2 shows the properties of three types of SILQUEST® silanes used in the testing, both for Example 1 and Example 2.

TABLE 1

| Reinforced PPS | Sample | Sample | Sample | Sample |
|---|---|---|---|---|
| Polymer Composition | #1 | #2 | #3 | #4 |
| PPS Lot 1 | 30.00% | 29.50% | 30.00% | 29.50% |
| PPS Lot 2 | 29.75% | 29.75% | 29.75% | 29.75% |
| Glass Fiber Type I | 40.00% | 40.00% | — | — |
| Glass Fiber Type II | — | — | 40.00% | 40.00% |
| SILQUEST ® A-1524 | — | 0.50% | — | 0.50% |
| silane | | | | |
| HDPE | 0.25% | 0.25% | 0.25% | 0.25% |

ISO 527-2 (1993) Tensile Testing, 0 Hours in Water at 140° C.

| | | | | |
|---|---|---|---|---|
| Tensile Strain, % | 1.49 | 1.73 | 1.55 | 1.69 |
| Tensile Strength, MPa | 162.0 | 188.8 | 165.4 | 187.0 |
| Tensile Modulus, MPa | 14655 | 14543 | 14500 | 15051 |

ISO 527-2 (1993) Tensile Testing, 500 Hours in Water at 140° C.

| | | | | |
|---|---|---|---|---|
| Tensile Strain, % | 1.00 | 1.43 | 1.05 | 1.43 |
| Tensile Strength, MPa | 107.0 | 161.8 | 112.6 | 156.1 |
| Tensile Modulus, MPa | 12569 | 13642 | 12832 | 13857 |

ISO 527-2 (1993) Tensile Testing, 1000 Hours in Water at 140° C.

| | | | | |
|---|---|---|---|---|
| Tensile Strain, % | 0.98 | 1.34 | 1.02 | 1.39 |
| Tensile Strength, MPa | 104.1 | 154.5 | 107.9 | 150.7 |
| Tensile Modulus, MPa | 12867 | 14117 | 12719 | 14194 |

ISO 527-2 (1993) Tensile Testing, 2000 Hours in Water at 140° C.

| | | | | |
|---|---|---|---|---|
| Tensile Strain, % | 0.92 | 1.25 | 0.93 | 1.37 |
| Tensile Strength, MPa | 98.1 | 146.6 | 99.6 | 148.6 |
| Tensile Modulus, MPa | 13170 | 13896 | 12913 | 14085 |

ISO 527-2 (1993) Tensile Testing, 500 Hours in Water at 140° C.

| | | | | |
|---|---|---|---|---|
| Tensile Strain Retention, % | 67 | 83 | 68 | 85 |
| Tensile Strength | 66 | 86 | 68 | 83 |
| Retention, % | | | | |
| Tensile Modulus | 86 | 94 | 88 | 92 |
| Retention, % | | | | |
| Weight Gain (Water | 0.27 | 0.22 | 0.23 | 0.25 |
| Absorption), % | | | | |

ISO 527-2 (1993) Tensile Testing, 1000 Hours in Water at 140° C.

| | | | | |
|---|---|---|---|---|
| Tensile Strain Retention, % | 66 | 77 | 66 | 82 |
| Tensile Strength | 64 | 82 | 65 | 81 |
| Retention, % | | | | |
| Tensile Modulus | 88 | 97 | 88 | 94 |
| Retention, % | | | | |
| Weight Gain (Water | 0.31 | 0.30 | 0.28 | 0.33 |
| Absorption), % | | | | |

ISO 527-2 (1993) Tensile Testing, 2000 Hours in Water at 140° C.

| | | | | |
|---|---|---|---|---|
| Tensile Strain Retention, % | 62 | 72 | 60 | 81 |
| Tensile Strength | 61 | 78 | 60 | 79 |
| Retention, % | | | | |
| Tensile Modulus | 90 | 96 | 89 | 94 |
| Retention, % | | | | |
| Weight Gain (Water | 0.22 | 0.35 | 0.22 | 0.41 |
| Absorption), % | | | | |

TABLE 2

| | | | Methyl |
|---|---|---|---|
| | γ-ureidopropyltrimethoxy | Methanol | Carbamate |
| SILQUEST ® | Silane Content | Content | Content |
| SILQUEST ® | 60-100% | 0.1-1% | 1-5% |
| A-1524 silane | | | |
| SILQUEST ® | <100.0% | <0.9% | <2.0% |
| Y-11542 silane | | | |
| | | | Methyl |
| | γ-glycidoxypropyltrimethoxy | Methanol | Carbamate |
| SILQUEST ® | Silane Content | Content | Content |
| SILQUEST ® | >90% | <1% | — |
| A-187 silane | | | |

The amounts of ingredients/components in each composition are expressed as weight %, based on the total weight of the composition. PPS polymers from two different batches were used (e.g., PPS Lot 1, PPS Lot 2), and two different types of glass fibers were used (e.g., Glass Fiber Type I, Glass Fiber Type II). Sample #1 and Sample #3 were control samples, as they contained no silane. The data in Table 1 illustrate how the use of the SILQUEST® A-1524 silane improves mechanical strength of the polymer composition and enhances retention of mechanical strength of the polymer composition after aging in water at 140° C. Comparing Sample #1 to Sample #2, and comparing Sample #3 to Sample #4, it can be seen that use of SILQUEST® A-1524 silane gives better tensile strength and tensile strain before hot water aging, better tensile strength and tensile strain after hot water aging, and a higher % tensile strength retention and % tensile strain retention after hot water aging.

### Example 2

The properties of reinforced PPS polymer compositions were investigated. More specifically, the tensile strength, the tensile modulus, and the tensile strain for reinforced PPS polymer compositions samples were investigated both for samples with and without an ureido silane coupling agent. The % tensile strength retention, the % tensile modulus retention, and the % tensile strain retention were calculated from the available data as described previously herein.

The reinforced PPS (polyphenylene sulfide) polymer composition samples were prepared as described in Example 1. PPS Lot 3 is comparable to RYTON® PR27 PPS; and PPS Lot 4 is a pilot-plant produced sample (not commercially available) that is most similar to RYTON® QA250N PPS. Tensile tests were conducted as described in Example 1 and in accordance with standard test methods ASTM D638-03 (in the case of Example 2) and the data are displayed in Table 3.

TABLE 3

| | Sample # | | | | | |
|---|---|---|---|---|---|---|
| Reinforced PPS Polymer Composition | 5 | 6 | 7 | 8 | 9 | 10 |
| PPS Lot 3 | 57.32% | 57.29% | 57.61% | — | — | — |
| PPS Lot 4 | — | — | — | 57.32% | 57.29% | 57.61% |
| Glass Fiber Type III | 41.04% | 41.03% | 41.25% | 41.04% | 41.03% | 41.25% |
| SILQUEST ® Y-11542 silane | 0.50% | — | — | 0.50% | — | — |
| SILQUEST ® A-187 silane | — | 0.54% | — | — | 0.54% | — |
| Hydrotalcite | 1.00% | 1.00% | 1.00% | 1.00% | 1.00% | 1.00% |
| HDPE | 0.14% | 0.14% | 0.14% | 0.14% | 0.14% | 0.14% |

ASTM D638-03 Tensile Testing, 0 Hours in Water at 140° C.

| | | | | | | |
|---|---|---|---|---|---|---|
| Tensile Strain, % | 1.41 | 1.62 | 1.29 | 1.54 | 1.64 | 1.41 |
| Tensile Strength, kpsi | 26.0 | 27.9 | 24.0 | 26.8 | 27.6 | 24.7 |
| Tensile Modulus, Mpsi | 2.45 | 2.39 | 2.42 | 2.44 | 2.43 | 2.35 |

ASTM D638-03 Tensile Testing, 250 Hours in Water at 140° C.

| | | | | | | |
|---|---|---|---|---|---|---|
| Tensile Strain, % | 1.05 | 1.13 | 0.99 | 1.27 | 1.14 | 1.16 |
| Tensile Strength, kpsi | 19.8 | 17.6 | 18.0 | 22.3 | 17.9 | 20.8 |
| Tensile Modulus, Mpsi | 2.37 | 2.12 | 2.32 | 2.31 | 2.25 | 2.23 |

ASTM D638-03 Tensile Testing, 500 Hours in Water at 140° C.

| | | | | | | |
|---|---|---|---|---|---|---|
| Tensile Strain, % | 1.04 | 1.03 | 0.97 | 1.19 | 1.15 | 1.10 |
| Tensile Strength, kpsi | 19.4 | 15.8 | 17.2 | 21.0 | 17.7 | 19.4 |
| Tensile Modulus, Mpsi | 2.25 | 2.34 | 2.26 | 2.16 | 2.03 | 2.30 |

ASTM D638-03 Tensile Testing, 1000 Hours in Water at 140° C.

| | | | | | | |
|---|---|---|---|---|---|---|
| Tensile Strain, % | 0.98 | 1.11 | 0.93 | 1.16 | 1.09 | 1.16 |
| Tensile Strength, kpsi | 16.7 | 13.1 | 15.3 | 19.4 | 14.6 | 18.5 |
| Tensile Modulus, Mpsi | 2.07 | 2.05 | 2.17 | 2.20 | 2.08 | 2.28 |

ASTM D638-03 Tensile Testing, 2000 Hours in Water at 140° C.

| | | | | | | |
|---|---|---|---|---|---|---|
| Tensile Strain, % | 0.98 | 1.03 | 0.97 | 1.23 | 1.16 | 1.08 |
| Tensile Strength, kpsi | 17.5 | 13.8 | 16.4 | 21.5 | 15.2 | 18.9 |
| Tensile Modulus, Mpsi | 2.52 | 2.50 | 2.61 | 2.67 | 2.51 | 2.37 |

ASTM D638-03 Tensile Testing, 250 Hours in Water at 140° C.

| | | | | | | |
|---|---|---|---|---|---|---|
| Tensile Strain Retention, % | 74 | 70 | 77 | 82 | 70 | 82 |
| Tensile Strength Retention, % | 76 | 63 | 75 | 83 | 65 | 84 |
| Tensile Modulus Retention, % | 97 | 89 | 96 | 95 | 93 | 95 |
| Weight Gain (Water Absorption), % | 0.85 | 1.35 | 0.83 | 0.50 | 0.88 | 0.52 |

ASTM D638-03 Tensile Testing, 500 Hours in Water at 140° C.

| | | | | | | |
|---|---|---|---|---|---|---|
| Tensile Strain Retention, % | 74 | 64 | 75 | 77 | 70 | 78 |
| Tensile Strength Retention, % | 75 | 57 | 72 | 79 | 64 | 79 |
| Tensile Modulus Retention, % | 92 | 98 | 93 | 89 | 84 | 98 |
| Weight Gain (Water Absorption), % | 1.09 | 1.69 | 1.21 | 0.74 | 1.17 | 0.78 |

ASTM D638-03 Tensile Testing, 1000 Hours in Water at 140° C.

| | | | | | | |
|---|---|---|---|---|---|---|
| Tensile Strain Retention, % | 70 | 69 | 72 | 75 | 66 | 82 |
| Tensile Strength Retention, % | 64 | 47 | 64 | 73 | 53 | 75 |
| Tensile Modulus Retention, % | 84 | 86 | 90 | 90 | 86 | 97 |
| Weight Gain (Water Absorption), % | 1.33 | 1.41 | 1.32 | 0.83 | 0.74 | 0.75 |

ASTM D638-03 Tensile Testing, 2000 Hours in Water at 140° C.

| | | | | | | |
|---|---|---|---|---|---|---|
| Tensile Strain Retention, % | 70 | 64 | 75 | 80 | 71 | 77 |
| Tensile Strength Retention, % | 67 | 50 | 69 | 80 | 55 | 77 |
| Tensile Modulus Retention, % | 103 | 105 | 108 | 110 | 103 | 101 |
| Weight Gain (Water Absorption), % | 1.40 | 1.58 | 1.47 | 0.98 | 0.94 | 0.76 |

The amounts of ingredients/components in each composition are expressed as weight %, based on the total weight of the composition. PPS polymers from two different batches were used (e.g., PPS Lot 3, PPS Lot 4), and one type of glass fiber was used (e.g., Glass Fiber Type III). Sample #7 and Sample #10 were control samples, as they contained no silane. SILQUEST® A-187 silane is a y-glycidoxypropyltrimethoxy silane commercially available from Momentive Performance Materials. The Glass Fiber Type III was a surface-treated glass fiber, wherein the surface of the glass fiber was pre-treated with coupling agents by the supplier, which could inherently provide enhanced mechanical strength retention after hot water aging. However, the data in Table 3 indicate that the addition of either SILQUEST® Y-11542 silane or SILQUEST® A-187 silane provides an enhancement in mechanical strength. Comparing Sample #5 or Sample #6 to Sample #7, and comparing Sample #8 or Sample #9 to Sample #10, it can be seen that the use of either silane (e.g., SILQUEST® Y-11542 silane or SILQUEST® A-187 silane) gives better tensile strength before hot water aging (0 hours).

Using SILQUEST® Y-11542 silane (an ureido silane coupling agent) exhibited much better retention of the enhanced mechanical strength after hot water aging at 140° C., when compared to using SILQUEST® A-187 silane (not an ureido silane coupling agent). Comparing Sample #5 to Sample #6, and comparing Sample #8 to Sample #9, it can be seen that use of SILQUEST® Y-11542 silane gives better tensile strength after hot water aging, and a higher percent retention of tensile strength after hot water aging than use of SILQUEST® A-187 silane.

### ADDITIONAL DISCLOSURE

A first embodiment, which is a reinforced poly(arylene sulfide) polymer composition comprising:

(a) a poly(arylene sulfide) polymer;
(b) a hydroxyl-functionalized reinforcing material; and
(c) an ureido silane coupling agent comprising a compound represented by Formula IV and/or a compound represented by Formula V:

H₂N—CO—NH—CₘH₂ₘ—Si(OR⁵)₃ Formula IV

H₂N—CO—NH—CₓH_{y}—Si(OR⁵)₃ Formula V

wherein m is an integer with a value of equal to or greater than 1; wherein x and y both are integers; wherein x has a value of equal to or greater than 1; wherein y has a value of equal to or greater than 2; wherein R⁵ is any hydrocarbon functionality;

wherein the hydroxyl-functionalized reinforcing material is present in the reinforced poly(arylene sulfide) polymer composition in an amount of from about 30 wt. % to about 45 wt. % based on the total weight of the reinforced poly(arylene sulfide) polymer composition; and

wherein the ureido silane coupling agent is present in the reinforced poly(arylene sulfide) polymer composition in an amount of from about 0.1 wt. % to about 1 wt. % based on the total weight of the reinforced poly(arylene sulfide) polymer composition.

A second embodiment, which is the reinforced poly(arylene sulfide) polymer composition of the first embodiment, wherein the compound represented by Formula IV and/or the compound represented by Formula V comprise a γ-ureidopropyltrialkoxy silane represented by Formula VI:

H₂N—CO—NH—CH₂—CH₂—CH₂—Si(OR)₃ Formula VI

wherein R⁵ is an alkyl group.

A third embodiment, which is the reinforced poly(arylene sulfide) polymer composition of the second embodiment, wherein the γ-ureidopropyltrialkoxy silane represented by Formula VI comprises a γ-ureidopropyltrimethoxy silane represented by Formula VII and/or a γ-ureidopropyltriethoxy silane represented by Formula VIII:

H₂N—CO—NH—CH₂—CH₂—CH₂—Si(OCH₃)₃ Formula VII

H₂N—CO—NH—CH₂—CH₂—CH₂—Si(OC₂H₅)₃ Formula VIII

A fourth embodiment, which is the reinforced poly(arylene sulfide) polymer composition of any of the first through the third embodiments, wherein the hydroxyl-functionalized reinforcing material comprises glass fibers.

A fifth embodiment, which is the reinforced poly(arylene sulfide) polymer composition of any of the first through the fourth embodiments, wherein the hydroxyl-functionalized reinforcing material comprises fibers having a fiber length of from about 0.01 mm to about 1.0 mm.

A sixth embodiment, which is the reinforced poly(arylene sulfide) polymer composition of any of the first through the fifth embodiments, wherein the hydroxyl-functionalized reinforcing material comprises fibers having a fiber diameter of from about 5 microns to about 15 microns.

A seventh embodiment, which is the reinforced poly(arylene sulfide) polymer composition of any of the first through the sixth embodiments, wherein the hydroxyl-functionalized reinforcing material comprises fibers having a fiber aspect ratio of from about 1 to about 200.

An eighth embodiment, which is the reinforced poly(arylene sulfide) polymer composition of any of the first through the seventh embodiments, wherein the poly(arylene sulfide) polymer is formed by reacting a sulfur source and a dihaloaromatic compound in the presence of a polar organic compound.

A ninth embodiment, which is the reinforced poly(arylene sulfide) polymer composition of any of the first through the eighth embodiments, wherein the poly(arylene sulfide) is a poly(phenylene sulfide).

A tenth embodiment, which is the reinforced poly(arylene sulfide) polymer composition of any of the first through the ninth embodiments displaying a tensile strength as determined in accordance with ASTM D638-03 and/or ISO 527-2 (1993) that is increased by from about 10 MPa to about 50 MPa when compared to an otherwise similar reinforced polymer composition lacking the ureido silane coupling agent.

An eleventh embodiment, which is the reinforced poly(arylene sulfide) polymer composition of any of the first through the tenth embodiments displaying a tensile modulus as determined in accordance with ASTM D638-03 and/or ISO 527-2 (1993) that is increased by from about 100 MPa to about 1,000 MPa when compared to an otherwise similar reinforced polymer composition lacking the ureido silane coupling agent.

A twelfth embodiment, which is the reinforced poly(arylene sulfide) polymer composition of any of the first through the eleventh embodiments displaying a % tensile strength retention that is increased by equal to or greater than about 15% when compared to an otherwise similar reinforced polymer composition lacking the ureido silane coupling agent, wherein the tensile strength is determined in accordance with ASTM D638-03 and/or ISO 527-2 (1993), and wherein the polymer composition is aged in hot water at about 140° C. over about 2000 hours.

A thirteenth embodiment, which is the reinforced poly(arylene sulfide) polymer composition of any of the first through the twelfth embodiments displaying a % tensile modulus retention that is increased by equal to or greater than about 5% when compared to an otherwise similar reinforced polymer composition lacking the ureido silane coupling agent, wherein the tensile modulus is determined in accordance with ASTM D638-03 and/or ISO 527-2 (1993), and wherein the polymer composition is aged in hot water at about 140° C. over about 2000 hours.

A fourteenth embodiment, which is the reinforced poly(arylene sulfide) polymer composition of any of the first through the thirteenth embodiments displaying a % tensile strain retention that is increased by equal to or greater than about 10% when compared to an otherwise similar reinforced polymer composition lacking the ureido silane coupling agent, wherein the tensile strain is determined in accordance with ASTM D638-03 and/or ISO 527-2 (1993), and wherein the polymer composition is aged in hot water at about 140° C. over about 2000 hours.

A fifteenth embodiment, which is the reinforced poly(arylene sulfide) polymer composition of any of the first through the fourteenth embodiments formed into an article.

A sixteenth embodiment, which is the reinforced poly(arylene sulfide) polymer composition of the fifteenth embodiment, wherein the article comprises a component of an automotive coolant system, a component of a hot water plumbing assembly, and/or a component of a hot water appliance.

A seventeenth embodiment, which is the reinforced poly(arylene sulfide) polymer composition of any of the fifteenth through the sixteenth embodiments, wherein the article is a pipe.

An eighteenth embodiment, which is a method comprising:

compound extruding a reinforced poly(arylene sulfide) polymer composition in a compounding extruder and forming an extruded article, wherein the reinforced poly(arylene sulfide) polymer composition comprises:

(a) a poly(arylene sulfide) polymer;
(b) a hydroxyl-functionalized reinforcing material; and
(c) an ureido silane coupling agent comprising a compound represented by Formula IV and/or a compound represented by Formula V:

H₂N—CO—NH—CₘH₂ₘ—Si(OR⁵)₃ Formula IV

H₂N—CO—NH—CₓH_{y}—Si(OR⁵)₃ Formula V

wherein m is an integer with a value of equal to or greater than 1; wherein x and y both are integers; wherein x has a value of equal to or greater than 1; wherein y has a value of equal to or greater than 2; wherein R⁵ is any hydrocarbon functionality;

wherein the hydroxyl-functionalized reinforcing material is present in the reinforced poly(arylene sulfide) polymer composition in an amount of from about 30 wt. % to about 45 wt. % based on the total weight of the reinforced poly(arylene sulfide) polymer composition; and

wherein the ureido silane coupling agent is present in the reinforced poly(arylene sulfide) polymer composition in an amount of from about 0.1 wt. % to about 1 wt. % based on the total weight of the reinforced poly(arylene sulfide) polymer composition.

A nineteenth embodiment, which is the method of the eighteenth embodiment, wherein the poly(arylene sulfide) polymer and the ureido silane coupling agent are mixed together to form a polymer mixture, and wherein the polymer mixture and the hydroxyl-functionalized reinforcing material are added to the compounding extruder at the same time.

A twentieth embodiment, which is the method of any of the eighteenth through the nineteenth embodiments, wherein the hydroxyl-functionalized reinforcing material and the ureido silane coupling agent are mixed together to form a reinforcing material mixture, and wherein the reinforcing material mixture and the poly(arylene sulfide) polymer are added to the compounding extruder at the same time.

A twenty-first embodiment, which is the method of any of the eighteenth through the twentieth embodiments, wherein the poly(arylene sulfide) polymer and the hydroxyl-functionalized reinforcing material and are mixed together to form a reinforcing polymer mixture, and wherein the reinforcing polymer mixture and the ureido silane coupling agent are added to the compounding extruder at the same time.

A twenty-second embodiment, which is an extruded or molded article comprising a reinforced poly(arylene sulfide) polymer composition comprising:

(a) a poly(arylene sulfide) polymer;
(b) a hydroxyl-functionalized reinforcing material; and
(c) an ureido silane coupling agent comprising a compound represented by Formula IV and/or a compound represented by Formula V:

H₂N—CO—NH—CₘH₂ₘ—Si(OR⁵)₃ Formula IV

H₂N—CO—NH—CₓH_{y}—Si(OR⁵)₃ Formula V

wherein m is an integer with a value of equal to or greater than 1; wherein x and y both are integers; wherein x has a value of equal to or greater than 1; wherein y has a value of equal to or greater than 2; wherein R⁵ is any hydrocarbon functionality;

wherein the hydroxyl-functionalized reinforcing material is present in the reinforced poly(arylene sulfide) polymer composition in an amount of from about 30 wt. % to about 45 wt. % based on the total weight of the reinforced poly(arylene sulfide) polymer composition; and

wherein the ureido silane coupling agent is present in the reinforced poly(arylene sulfide) polymer composition in an amount of from about 0.1 wt. % to about 1 wt. % based on the total weight of the reinforced poly(arylene sulfide) polymer composition.

A twenty-third embodiment, which is a reinforced poly(phenylene sulfide) polymer composition comprising:

(a) a poly(phenylene sulfide) polymer;
(b) a hydroxyl-functionalized reinforcing material comprising glass fibers; and
(c) an ureido silane coupling agent comprising a γ-ureidopropyltrimethoxy silane represented by Formula VII and/or a γ-ureidopropyltriethoxy silane represented by Formula VIII:

H₂N—CO—NH—CH₂—CH₂—CH₂—Si(OCH₃)₃ Formula VII

H₂N—CO—NH—CH₂—CH₂—CH₂—Si(OC₂H₅)₃ Formula VIII

wherein the hydroxyl-functionalized reinforcing material is present in the reinforced poly(phenylene sulfide) polymer composition in an amount of from about 30 wt. % to about 45 wt. % based on the total weight of the reinforced poly(phenylene sulfide) polymer composition; and

wherein the ureido silane coupling agent is present in the reinforced poly(phenylene sulfide) polymer composition in an amount of from about 0.1 wt. % to about 1 wt. % based on the total weight of the reinforced poly(phenylene sulfide) polymer composition.

A twenty-fourth embodiment, which is a method comprising:

compound extruding a reinforced poly(phenylene sulfide) polymer composition in a compounding extruder and forming an extruded article, wherein the reinforced poly(phenylene sulfide) polymer composition comprises:

(a) a poly(phenylene sulfide) polymer;
(b) a hydroxyl-functionalized reinforcing material comprising glass fibers; and
(c) an ureido silane coupling agent comprising a γ-ureidopropyltrimethoxy silane represented by Formula VII and/or a γ-ureidopropyltriethoxy silane represented by Formula VIII:

H₂N—CO—NH—CH₂—CH₂—CH₂—Si(OCH₃)₃ Formula VII

H₂N—CO—NH—CH₂—CH₂—CH₂—Si(OC₂H₅)₃ Formula VIII

wherein the hydroxyl-functionalized reinforcing material is present in the reinforced poly(phenylene sulfide) polymer composition in an amount of from about 30 wt. % to about 45 wt. % based on the total weight of the reinforced poly(phenylene sulfide) polymer composition; and

wherein the ureido silane coupling agent is present in the reinforced poly(phenylene sulfide) polymer composition in an amount of from about 0.1 wt. % to about 1 wt. % based on the total weight of the reinforced poly(phenylene sulfide) polymer composition.

A twenty-fifth embodiment, which is an extruded or molded article comprising a reinforced poly(phenylene sulfide) polymer composition comprising:

(a) a poly(phenylene sulfide) polymer;
(b) a hydroxyl-functionalized reinforcing material comprising glass fibers; and
(c) an ureido silane coupling agent comprising a γ-ureidopropyltrimethoxy silane represented by Formula VII and/or a γ-ureidopropyltriethoxy silane represented by Formula VIII:

H₂N—CO—NH—CH₂—CH₂—CH₂—Si(OCH₃)₃ Formula VII

H₂N—CO—NH—CH₂—CH₂—CH₂—Si(OC₂H₅)₃ Formula VIII

wherein the hydroxyl-functionalized reinforcing material is present in the reinforced poly(phenylene sulfide) polymer composition in an amount of from about 30 wt. % to about 45 wt. % based on the total weight of the reinforced poly(phenylene sulfide) polymer composition; and

wherein the ureido silane coupling agent is present in the reinforced poly(phenylene sulfide) polymer composition in an amount of from about 0.1 wt. % to about 1 wt. % based on the total weight of the reinforced poly(phenylene sulfide) polymer composition.

A twenty-sixth embodiment, which is a hot water conveyance assembly comprising at least one fiber-reinforced, extruded component in contact with said hot water, wherein said fiber-reinforced, extruded component is formed via extrusion of a reinforced poly(phenylene sulfide) polymer composition comprising:

(a) a poly(phenylene sulfide) polymer;
(b) a hydroxyl-functionalized reinforcing material comprising glass fibers; and
(c) an ureido silane coupling agent comprising a γ-ureidopropyltrimethoxy silane represented by Formula VII and/or a γ-ureidopropyltriethoxy silane represented by Formula VIII:

H₂N—CO—NH—CH₂—CH₂—CH₂—Si(OCH₃)₃ Formula VII

H₂N—CO—NH—CH₂—CH₂—CH₂—Si(OC₂H₅)₃ Formula VIII

wherein the hydroxyl-functionalized reinforcing material is present in the reinforced poly(phenylene sulfide) polymer composition in an amount of from about 30 wt. % to about 45 wt. % based on the total weight of the reinforced poly(phenylene sulfide) polymer composition; and

wherein the ureido silane coupling agent is present in the reinforced poly(phenylene sulfide) polymer composition in an amount of from about 0.1 wt. % to about 1 wt. % based on the total weight of the reinforced poly(phenylene sulfide) polymer composition.

A twenty-seventh embodiment, which is a hot water conveyance assembly of the twenty-sixth embodiment wherein the fiber-reinforced, extruded component is a pipe.

While embodiments of the disclosure have been shown and described, modifications thereof can be made without departing from the spirit and teachings of the invention. The embodiments and examples described herein are exemplary only, and are not intended to be limiting. Many variations and modifications of the invention disclosed herein are possible and are within the scope of the invention.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the detailed description of the present invention. The disclosures of all patents, patent applications, and publications cited herein are hereby incorporated by reference.

What is claimed is:

1. A reinforced poly(arylene sulfide) polymer composition comprising:
(a) a poly(arylene sulfide) polymer;
(b) a hydroxyl-functionalized reinforcing material; and
(c) an ureido silane coupling agent comprising a compound represented by Formula IV and/or a compound represented by Formula V:
H₂N—CO—NH—CₘH₂ₘ—Si(OR⁵)₃ Formula IV
H₂N—CO—NH—CₓH_{y}—Si(OR⁵)₃ Formula V
wherein m is an integer with a value of equal to or greater than 1; wherein x and y both are integers; wherein x has a value of equal to or greater than 1; wherein y has a value of equal to or greater than 2; wherein R⁵ is any hydrocarbon functionality;
wherein the hydroxyl-functionalized reinforcing material is present in the reinforced poly(arylene sulfide) polymer composition in an amount of from about 30 wt. % to about 45 wt. % based on the total weight of the reinforced poly(arylene sulfide) polymer composition; and
wherein the ureido silane coupling agent is present in the reinforced poly(arylene sulfide) polymer composition in an amount of from about 0.1 wt. % to about 1 wt. % based on the total weight of the reinforced poly(arylene sulfide) polymer composition.

2. The reinforced poly(arylene sulfide) polymer composition of claim 1, wherein the compound represented by Formula IV and/or the compound represented by Formula V comprise a γ-ureidopropyltrialkoxy silane represented by Formula VI:
H₂N—CO—NH—CH₂—CH₂—CH₂—Si(OR)₃ Formula VI
wherein R⁵ is an alkyl group.

3. The reinforced poly(arylene sulfide) polymer composition of claim 2, wherein the γ-ureidopropyltrialkoxy silane represented by Formula VI comprises a γ-ureidopropyltrimethoxy silane represented by Formula VII and/or a γ-ureidopropyltriethoxy silane represented by Formula VIII:
H₂N—CO—NH—CH₂—CH₂—CH₂—Si(OCH₃)₃ Formula VII
H₂N—CO—NH—CH₂—CH₂—CH₂—Si(OC₂H₅)₃ Formula VIII

4. The reinforced poly(arylene sulfide) polymer composition of claim 1, wherein the hydroxyl-functionalized reinforcing material comprises glass fibers.

5. The reinforced poly(arylene sulfide) polymer composition of claim 1, wherein the hydroxyl-functionalized reinforcing material comprises fibers having a fiber length of from about 0.01 mm to about 1.0 mm.

6. The reinforced poly(arylene sulfide) polymer composition of claim 1, wherein the hydroxyl-functionalized reinforcing material comprises fibers having a fiber diameter of from about 5 microns to about 15 microns.

7. The reinforced poly(arylene sulfide) polymer composition of claim 1, wherein the hydroxyl-functionalized reinforcing material comprises fibers having a fiber aspect ratio of from about 1 to about 200.

8. The reinforced poly(arylene sulfide) polymer composition of claim 1, wherein the poly(arylene sulfide) polymer is formed by reacting a sulfur source and a dihaloaromatic compound in the presence of a polar organic compound.

9. The reinforced poly(arylene sulfide) polymer composition of claim 1, wherein the poly(arylene sulfide) is a poly(phenylene sulfide).

10. The reinforced poly(arylene sulfide) polymer composition of claim 1 displaying a tensile strength as determined in accordance with ASTM D638-03 and/or ISO 527-2 (1993) that is increased by from about 10 MPa to about 50 MPa when compared to an otherwise similar reinforced polymer composition lacking the ureido silane coupling agent.

11. The reinforced poly(arylene sulfide) polymer composition of claim 1 displaying a tensile modulus as determined in accordance with ASTM D638-03 and/or ISO 527-2 (1993) that is increased by from about 100 MPa to about 1,000 MPa when compared to an otherwise similar reinforced polymer composition lacking the ureido silane coupling agent.

12. The reinforced poly(arylene sulfide) polymer composition of claim 1 displaying a % tensile strength retention that is increased by equal to or greater than about 15% when compared to an otherwise similar reinforced polymer composition lacking the ureido silane coupling agent, wherein the tensile strength is determined in accordance with ASTM D638-03 and/or ISO 527-2 (1993), and wherein the polymer composition is aged in hot water at about 140° C. over about 2000 hours.

13. The reinforced poly(arylene sulfide) polymer composition of claim 1 displaying a % tensile modulus retention that is increased by equal to or greater than about 5% when compared to an otherwise similar reinforced polymer composition lacking the ureido silane coupling agent, wherein the tensile modulus is determined in accordance with ASTM D638-03 and/or ISO 527-2 (1993), and wherein the polymer composition is aged in hot water at about 140° C. over about 2000 hours.

14. The reinforced poly(arylene sulfide) polymer composition of claim 1 displaying a % tensile strain retention that is increased by equal to or greater than about 10% when compared to an otherwise similar reinforced polymer composition lacking the ureido silane coupling agent, wherein the tensile strain is determined in accordance with ASTM D638-03 and/or ISO 527-2 (1993), and wherein the polymer composition is aged in hot water at about 140° C. over about 2000 hours.

15. The reinforced poly(arylene sulfide) polymer composition of claim 1 formed into an article.

16. The reinforced poly(arylene sulfide) polymer composition of claim 15, wherein the article comprises a component of an automotive coolant system, a component of a hot water plumbing assembly, and/or a component of a hot water appliance.

17. The reinforced poly(arylene sulfide) polymer composition of claim 15, wherein the article is a pipe.

18. A method comprising:
compound extruding a reinforced poly(arylene sulfide) polymer composition in a compounding extruder and forming an extruded article, wherein the reinforced poly(arylene sulfide) polymer composition comprises:
(a) a poly(arylene sulfide) polymer;
(b) a hydroxyl-functionalized reinforcing material; and
(c) an ureido silane coupling agent comprising a compound represented by Formula IV and/or a compound represented by Formula V:
H₂N—CO—NH—CₘH₂ₘ—Si(OR⁵)₃ Formula IV
H₂N—CO—NH—CₓH_{y}—Si(OR⁵)₃ Formula V
wherein m is an integer with a value of equal to or greater than 1; wherein x and y both are integers; wherein x has a value of equal to or greater than 1; wherein y has a value of equal to or greater than 2; wherein R⁵ is any hydrocarbon functionality;
wherein the hydroxyl-functionalized reinforcing material is present in the reinforced poly(arylene sulfide) polymer composition in an amount of from about 30 wt. % to about 45 wt. % based on the total weight of the reinforced poly(arylene sulfide) polymer composition; and
wherein the ureido silane coupling agent is present in the reinforced poly(arylene sulfide) polymer composition in an amount of from about 0.1 wt. % to about 1 wt. % based on the total weight of the reinforced poly(arylene sulfide) polymer composition.

19. The method of claim 18, wherein the poly(arylene sulfide) polymer and the ureido silane coupling agent are mixed together to form a polymer mixture, and wherein the polymer mixture and the hydroxyl-functionalized reinforcing material are added to the compounding extruder at the same time.

20. The method of claim 18, wherein the hydroxyl-functionalized reinforcing material and the ureido silane coupling agent are mixed together to form a reinforcing material mixture, and wherein the reinforcing material mixture and the poly(arylene sulfide) polymer are added to the compounding extruder at the same time.

21. The method of claim 18, wherein the poly(arylene sulfide) polymer and the hydroxyl-functionalized reinforcing material and are mixed together to form a reinforcing polymer mixture, and wherein the reinforcing polymer mixture and the ureido silane coupling agent are added to the compounding extruder at the same time.

22. An extruded or molded article comprising a reinforced poly(arylene sulfide) polymer composition comprising:
(a) a poly(arylene sulfide) polymer;
(b) a hydroxyl-functionalized reinforcing material; and
(c) an ureido silane coupling agent comprising a compound represented by Formula IV and/or a compound represented by Formula V:
H₂N—CO—NH—CₘH₂ₘ—Si(OR⁵)₃ Formula IV
H₂N—CO—NH—CₓH_{y}—Si(OR⁵)₃ Formula V
wherein m is an integer with a value of equal to or greater than 1; wherein x and y both are integers; wherein x has a value of equal to or greater than 1; wherein y has a value of equal to or greater than 2; wherein R⁵ is any hydrocarbon functionality;
wherein the hydroxyl-functionalized reinforcing material is present in the reinforced poly(arylene sulfide) polymer composition in an amount of from about 30 wt. % to about 45 wt. % based on the total weight of the reinforced poly(arylene sulfide) polymer composition; and
wherein the ureido silane coupling agent is present in the reinforced poly(arylene sulfide) polymer composition in an amount of from about 0.1 wt. % to about 1 wt. % based on the total weight of the reinforced poly(arylene sulfide) polymer composition.
